(19) United States
(12) Patent Application Publication
(10) Pub. No.: US 2006/0275692 A1
(43) Pub. Date: Dec. 7, 2006

(54) Method for forming concavo-convex pattern, method for manufacturing master disk, method for manufacturing stamper, and method for manufacturing magnetic recording medium

(75) Inventors: Shuichi Okawa, Tokyo (JP); Katsuyuki Nakada, Tokyo (JP); Kazuhiro Hattori, Tokyo (JP); Mitsuru Takai, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/445,336

(22) Filed: Jun. 2, 2006

(30) Foreign Application Priority Data
Jun. 2, 2005 (JP) 2005-162680
Aug. 25, 2005 (JP) 2005-244804

(51) Int. Cl. G03C 5/00

(52) U.S. Cl. 430/269

(57) ABSTRACT

A method for forming a concavo-convex pattern that can form a fine and complex concavo-convex pattern such as that corresponding to servo information with high precision, a method for manufacturing a master disk, a method for manufacturing a stamper, and a method for manufacturing a magnetic recording medium using that method for forming a concavo-convex pattern are provided. A resin layer formed over a resin layer supporting member is processed into an irregular concavo-convex pattern in which a dividing convex portion is formed in a part of concave portions of a predetermined basic concavo-convex pattern and at least some of concave portions are divided as compared with corresponding concave portions of the basic concavo-convex pattern. A recording layer (the resin layer supporting member) is etched based on the resin layer to be processed into a concavo-convex pattern obtained by bringing the irregular concavo-convex pattern close to the basic concavo-convex pattern.

### BACKGROUND OF THE INVENTION

1. Field of the Invention

The present invention relates to a method for forming a concavo-convex pattern, for example, a concavo-convex pattern corresponding to servo information of a magnetic recording medium, and a method for manufacturing a master disk, a method for manufacturing a stamper, and a method for manufacturing a magnetic recording medium that use the above method for forming a concavo-convex pattern.

2. Description of the Related Art

A method for forming a desired concavo-convex pattern is conventionally known in the art of manufacturing semiconductor products, for example. In this method, a resin layer of a resist material is formed over a resin layer supporting member. The resin layer is processed into a concavo-convex pattern by a technique called as lithography that uses exposure and development. Then, the resin layer supporting member is etched with the resin layer having the concavo-convex pattern used as a mask, so as to be processed into the concavo-convex pattern. In recent years, processing into a fine concavo-convex pattern containing concave portions or convex portions having a width of several hundreds nanometers or less or a pitch of several hundreds nanometers or less has been requested. In this case, electron beams are sometimes used for exposure because, when using light beams, effects of a wavelength of light cannot be ignored.

However, the method in which exposure (drawing) is performed for every product by using the electron beams has a problem of low production efficiency.

On the other hand, a method called as imprinting is known, which processes the resin layer into a concavo-convex pattern by bringing a stamper into contact with the resin layer (see Japanese Patent Laid-Open Publication No. 2003-100609, for example). In particular, in the case of transferring a fine concavo-convex pattern having a pitch of several hundreds nanometers or less, this method may be called as nano-imprinting. The resin layer is left in bottom of concave portions, after only a step of transferring the concavo-convex pattern by bringing the stamper into contact with the resin layer is performed. That is, the resin layer supporting member is not exposed. However, the resin layer supporting member can be exposed by uniformly etching the resin layer to such an extent that the resin layer in the bottom of the concave portions is removed. In this manner, the resin layer can be left as convex portions having a height corresponding to a step between the convex portion and the concave portion formed by the transfer process and can be used as a mask.

This imprinting method can largely improve productivity as compared with the aforementioned method that performs exposure using electron beams for every product.

In the art of magnetic recording medium such as hard disk, it is expected that a recording layer be processed into a concavo-convex pattern by using the method for forming a concavo-convex pattern described above for reasons set forth below.

A magnetic recording medium is sectioned into a plurality of data areas and a plurality of servo areas. In each servo area, servo information for positioning a magnetic head, for example, is recorded for use. Each servo area has a plurality of cell areas in each of which the servo information is recorded in a binary fashion, i.e., as either one of an information on 0 and an information on 1 in accordance with a predetermined rule. The servo information contains a preamble section for synchronization of a clock, a SAM section indicating start of servo data, a track address signal section indicating a track number, a sector address signal section indicating a sector number, and a burst signal section for tracking of a magnetic head, for example. The servo information is usually recorded on the magnetic recording medium in a servo track writing method. When the servo information is written, each cell area in the servo areas is magnetized one by one for every magnetic recording medium. Thus, the productivity is low. Especially in recent years, for achieving improvement of areal density and lowering of a flying height of the head, recording of the servo information with high density and precision is required and therefore needs for improvement of efficiency of recording the servo information are increased.

In order to achieve this, it is proposed to form portions of the recording layer in the servo areas into a concavo-convex pattern on which the servo information is reflected and in which cell areas for recording one of an information on 0 and an information on 1 are concave unit areas forming concave portions and the other cell areas for recording the other information is convex unit areas forming convex portions (see Japanese Patent Laid-Open Publications Nos. Hei 6-195907 and Hei 9-259426, for example). In a magnetic recording medium in which the portions of the recording layer in the servo areas are formed in the concavo-convex pattern on which the servo information is reflected, the recording layer can be magnetized in accordance with the pattern of the servo information by uniform application of a DC magnetic field. Therefore, the efficiency of recording the servo information can be largely improved.

For magnetic recording medium such as hard disk, various types of development such as miniaturization of magnetic particles forming a recording layer, change of material for the magnetic particles, and miniaturization of processing of a magnetic head have been made to largely improve areal density of the recording layer. The improvement of the areal density is expected to continue. However, many problems, e.g., limits of processing of the magnetic head, erroneous recording of information onto a track adjacent to a target track caused by broadening of a recording magnetic field of the magnetic head, and crosstalk during reproduction are made apparent. Therefore, the improvement of the areal density by the conventional development approach has reached the limit. In order to achieve further improvement of the areal density, a discrete track medium and a patterned medium, in which a recording layer is formed in a concavo-convex pattern and recording elements are formed as convex portions of the concavo-convex pattern, have been proposed. When manufacturing the discrete track medium and the patterned medium, a step for processing the recording layer to form the recording elements as the convex portions in data areas is performed. In this step, it is also possible to process a portion of the recording layer in servo areas into a concavo-convex pattern. Therefore, the discrete track medium and the patterned medium are advantageous especially in the production efficiency.

As described above, it is expected to use the aforementioned method for forming a concavo-convex pattern for processing the recording layer into a concavo-convex pattern corresponding to the servo information and a shape of tracks. In order to process the recording layer into the concavo-convex pattern, a resin layer may be formed directly on the recording layer. Alternatively, a method is proposed in which one or more mask layers are formed between the recording layer and the resin layer in accordance with circumstances, e.g., a material for the recording layer and a type of etching method and those layers are sequentially etched based on the resin layer having a concavo-convex pattern. In this manner, the recording layer is processed into the concavo-convex pattern.

In the art of optical recording media, a stamper is used for forming a concavo-convex pattern such as pits, grooves, and the like on a substrate. This method is different from imprinting described above. More specifically, a resin material such as polycarbonate is injection molded while a stamper is placed in a mold. In this manner, the substrate with a concavo-convex pattern for transferring information, such as pits and grooves, is obtained.

For the stamper for optical recording media, a manufacturing method is established. An exemplary manufacturing method will be described briefly. First, a resin layer of a resist material is formed on a substrate of glass or the like and is then partially removed by exposure and development of lithography. In this manner, a master disk which has a surface with a concavo-convex pattern is obtained. Then, a conductive film is deposited on the surface of the master disk by electroless plating or vapor deposition. An electrolytic plating layer of Ni (nickel) or the like is then formed by electrolytic plating using the conductive film as an electrode. When the conductive film and the electrolytic plating layer are separated as one unit from the master disk, the stamper is obtained (see Japanese Patent Laid-Open Publication No. Hei 5-205321, for example). The stamper thus obtained has a concavo-convex pattern obtained by reversing the concavo-convex pattern of the master disk. However, if the conductive film and the electrolytic plating layer that are separated from the master disk as one unit are used as a metal master (master disk) and a stamper is manufactured from the metal master by using electrolytic plating, the thus obtained stamper has the same concavo-convex pattern as the master disk. Moreover, another metal master may be formed from the metal master by repeating electrolytic plating one or more times.

It is expected to use the aforementioned method for manufacturing a stamper established in the art of optical recording medium for manufacturing a stamper for semiconductor products and magnetic recording medium.

However, it is actually difficult to form a fine and complex concavo-convex pattern like one corresponding to the servo information by using the aforementioned method for forming a concavo-convex pattern.

For example, it is difficult to precisely process the resin layer into a fine and complex concavo-convex pattern such as that corresponding to the servo information by lithography. In particular, the track address signal section has a complex pattern and it is difficult to precisely process the resin layer into a concavo-convex pattern corresponding to the track address signal section. Therefore, the resin layer supporting member under the resin layer cannot be processed into a desired concavo-convex pattern in some cases.

In addition, imprinting also uses the lithography technique for manufacturing the stamper. Therefore, it is also difficult to manufacture the stamper having a transfer surface with a fine and complex concavo-convex pattern corresponding to the servo information with sufficient precision. Moreover, even if a concavo-convex pattern can be formed on the transfer surface with sufficient precision, the resin layer cannot be processed precisely in accordance with the concavo-convex pattern of the stamper in some cases.

Furthermore, even if the resin layer can be processed into a desired concavo-convex pattern, that concavo-convex pattern may not be precisely reflected on the resin layer supporting member while the resin layer supporting member is etched based on the resin layer.

### SUMMARY OF THE INVENTION

In view of the foregoing problems, various exemplary embodiments of this invention provide a method for forming a concavo-convex pattern that can form a fine and complex concavo-convex pattern like one corresponding to servo information with high precision, and a method for manufacturing a master disk, a method for manufacturing a stamper, and a method for manufacturing a magnetic recording medium that use the above method for forming a concavo-convex pattern.

According to exemplary embodiments of the present invention, a resin layer formed over a resin layer supporting member is processed into an irregular concavo-convex pattern in which a dividing convex portion is formed in a part of the corresponding concave portion of a predetermined basic concavo-convex pattern, and at least some of concave portions are divided as compared with corresponding concave portions of the basic concavo-convex pattern, and the resin layer supporting member is etched based on the resin layer to be processed into a concavo-convex pattern obtained by bringing the irregular concavo-convex pattern close to the basic concavo-convex pattern, thereby achieving the object described above.

According to other exemplary embodiments of the present invention, a resin layer formed over a resin layer supporting member is processed into an irregular concavo-convex pattern in which a dividing convex portion is formed in a part of the corresponding concave portion of a predetermined basic concavo-convex pattern, and at least some of concave portions are divided as compared with corresponding concave portions of the basic concavo-convex pattern, and the resin layer is etched to be processed into a concavo-convex pattern obtained by bringing the irregular concavo-convex pattern close to the basic concavo-convex pattern, thereby achieving the object described above.

According to still other exemplary embodiments of the present invention, a resin layer formed over a resin layer supporting member is processed into an irregular concavo-convex pattern in which at least some of corners of convex portions projecting toward adjacent concave portions have projections that project more toward the adjacent concave portions as compared with corresponding corners of a predetermined basic concavo-convex pattern, and the resin layer supporting member is etched based on the resin layer to be processed into a concavo-convex pattern obtained by bringing the irregular concavo-convex pattern close to the basic concavo-convex pattern, thereby achieving the object described above.

According to still other exemplary embodiments of the present invention, a resin layer formed over a resin layer supporting member is processed into an irregular concavo-convex pattern in which at least some of corners of convex portions projecting toward adjacent concave portions have projections that project more toward the adjacent concave portions as compared with corresponding corners of a predetermined basic concavo-convex pattern, and the resin layer is etched to be processed into a concavo-convex pattern obtained by bringing the irregular concavo-convex pattern close to the basic concavo-convex pattern, thereby achieving the object described above.

In the process of conceiving the present invention, the inventors earnestly studied why it was difficult to form a fine and complex concavo-convex pattern with high precision and reached a conclusion that it was likely that several factors described below lowered process precision.

When processing a resin layer into a fine and complex concavo-convex pattern by lithography, it is important to adjust a dose in exposure to an appropriate value. However, if the dose is adjusted to a value that is appropriate for some of concave or convex portions having various widths included in the complex concavo-convex pattern, the thus adjusted value may be too large or insufficient for other concave or convex portions, thus preventing precise processing of the resin layer into the desired concavo-convex pattern.

In the case where the resin layer is processed into a concavo-convex pattern by imprinting, if the concavo-convex pattern contains concave portions having various widths, a variation occurs in thickness of resin remaining in the bottom of the concave portions in accordance with the widths of the concave portions after imprinting. Moreover, if the width of a certain concave portion is too large, resin remaining in the bottom of that concave portion tends to become thicker than that in other concave portions. The following is the reasons for this the inventors considered.

When a stamper is brought into contact with the resin layer, the resin pushed out by a convex portion of the stamper is moved to adjacent concave portions of the stamper. If a width of a concave portion of the resin layer is too large and a width of a convex portion of the stamper corresponding thereto is too large, the resin pushed out by that convex portion of the stamper does not move easily. For this reason, the resin is left in the bottom of the excessively wide concave portion of the resin layer to be thick. In addition, if the width of the concave portion of the resin layer is too large and the width of the corresponding convex portion of the stamper is too large, pressure acting on a region of the resin layer with which the convex portion of the stamper comes into contact is small. This may prevent sufficient plastic deformation of the resin, thus preventing formation of desired steps in an entire region of the resin layer.

After imprinting, when removing the resin layer in the bottom of the concave portion by uniformly etching the resin layer, the resin on side faces of the concave portion is also removed to slightly increase the width of the concave portion. Especially, in the case where there is a difference in thickness of the resin remaining in the bottom of the concave portion between the concave portions, it is considered that increase in the width of each concave portion is different between the concave portions and therefore the width of some of the concave portions may excessively increase. More specifically, when removal of the resin in the bottom of the concave portion is completed, a rate of removal of the resin on the side faces of the concave portion tends to increase. In a concave portion which has an excessively large width and in which the resin remaining in the bottom is thick, the resin in the bottom is removed relatively later. On the other hand, in another concave portion, the resin in the bottom is removed relatively faster and the rate of removal of the resin on the side face becomes faster. Thus, the width of the latter concave portion may excessively increase. This may prevent precise processing of the resin layer into a desired concavo-convex pattern.

Moreover, in the step of etching the resin layer or etching a resin layer supporting member based on the resin layer, convex portions of the resin layer and convex portions of a mask layer and the like are also removed partially. Thus, corners of convex portions projecting toward adjacent concave portions among convex portions can be easily removed and processed into a rounded shape. Therefore, corners of convex portions of the resin layer supporting member under the resin layer can be easily processed into a rounded shape, too. For this reason, the resin layer supporting member or the resin layer is not processed into a desired concavo-convex pattern in some cases.

On the other hand, in the case where the resin layer is processed by lithography into an irregular concavo-convex pattern in which at least some of concave portions are divided as compared with corresponding concave portions of the basic concavo-convex pattern, a range of the widths of the concave portions is limited to be smaller than that in the basic concavo-convex portion. Thus, it is possible to adjust a dose in exposure to a value close to an appropriate value for the entire region of the resin layer. Therefore, the resin layer can be processed into the irregular concavo-convex pattern with high precision. Note that, the dividing convex portion is significantly smaller in width than other convex portions of the resin layer. Thus, the dividing convex portion of the resin layer, a corresponding convex portion of a mask layer or the like, and a corresponding convex portion of the resin layer supporting member can be removed faster than the other convex portions of the resin layer during etching of the resin layer or etching of the resin layer supporting member based on the resin layer. Therefore, it is possible to process the resin layer supporting member or the resin layer into the basic concavo-convex pattern or a concavo-convex pattern obtained by bringing the irregular concavo-convex pattern close to the basic concavo-convex pattern.

In addition, in the case where the resin layer is processed by imprinting into the irregular concavo-convex pattern in which at least some of concave portions are divided as compared with corresponding concave portions of the basic concavo-convex pattern, a range of the widths of the concave portions is suppressed to be smaller than that in the basic concavo-convex pattern. Thus, the thickness of the resin layer left in the bottom of the concave portions becomes thin and uniform in the entire region of the resin layer. Therefore, while the resin layer is uniformly etched so as to remove the resin layer in the bottom of the concave portion after imprinting, it is possible to prevent or sufficiently suppress the increase in the width of the concave portion. Moreover, also in this case, the dividing convex portion of the resin layer, the corresponding convex portion of the mask layer or the like, and the corresponding convex portion of the resin layer supporting member can be removed faster than the other convex portions during uniform etching of the resin layer to remove the resin layer in the bottom of the concave portion and/or etching of the resin layer supporting member based on the resin layer. Therefore, the resin layer supporting member or the resin layer can be processed into the basic concavo-convex pattern or a concavo-convex pattern close to the basic concavo-convex pattern.

Moreover, when the resin layer is processed into an irregular concavo-convex pattern in which at least some of corners of convex portions projecting toward adjacent concave portions have projections that project more toward the adjacent concave portions as compared with corresponding corners of the basic concavo-convex pattern and thereafter the resin layer is etched or the mask layer or the like and the resin layer supporting member are etched based on the resin layer, the projections of the corners of the resin layer and corresponding projections of corners of convex portions of the mask layer and the resin layer supporting member are removed and those corners are processed into a shape close to the corresponding corners of the basic concavo-convex pattern. Therefore, the resin layer supporting member or the resin layer can be processed into the basic concavo-convex pattern or a concavo-convex pattern obtained by bringing the irregular concavo-convex pattern close to the basic concavo-convex pattern.

Accordingly, various exemplary embodiments of the present invention provide a method for forming a concavo-convex pattern comprising an irregular concavo-convex pattern formation step of processing a resin layer formed over a resin layer supporting member into an irregular concavo-convex pattern in which a dividing convex portion is formed in a part of concave portions of a predetermined basic concavo-convex pattern and at least some of concave portions are divided as compared with corresponding concave portions of the basic concavo-convex pattern; and a resin layer supporting member etching step of etching the resin layer supporting member based on the resin layer to process the resin layer supporting member into a concavo-convex pattern obtained by bringing the irregular concavo-convex pattern close to the basic concavo-convex pattern.

Alternatively, various exemplary embodiments of the present invention provide a method for forming a concavo-convex pattern comprising an irregular concavo-convex pattern formation step of processing a resin layer formed over a resin layer supporting member into an irregular concavo-convex pattern in which a dividing convex portion is formed in a part of concave portions of a predetermined basic concavo-convex pattern and at least some of concave portions are divided as compared with corresponding concave portions of the basic concavo-convex pattern; and a resin layer etching step of etching the resin layer to process the resin layer into a concavo-convex pattern obtained by bringing the irregular concavo-convex pattern close to the basic concavo-convex pattern.

Moreover, various exemplary embodiments of the present invention provide a method for forming a concavo-convex pattern comprising an irregular concavo-convex pattern formation step of processing a resin layer formed over a resin layer supporting member into an irregular concavo-convex pattern in which at least some of corners of convex portions projecting toward adjacent concave portions have projections that project more toward the adjacent concave portions as compared with corresponding corners of a predetermined basic concavo-convex pattern; and a resin layer supporting member etching step of etching the resin layer supporting member based on the resin layer to process the resin layer supporting member into a concavo-convex pattern obtained by bringing the irregular concavo-convex pattern close to the basic concavo-convex pattern.

Alternatively, various exemplary embodiments of the present invention provide a method for forming a concavo-convex pattern comprising an irregular concavo-convex pattern formation step of processing a resin layer formed over a resin layer supporting member into an irregular concavo-convex pattern in which at least some of corners of convex portions projecting toward adjacent concave portions have projections that project more toward the adjacent concave portions as compared with corresponding corners of a predetermined basic concavo-convex pattern; and a resin layer etching step of etching the resin layer to process the resin layer into a concavo-convex pattern obtained by bringing the irregular concavo-convex pattern close to the basic concavo-convex pattern.

Various exemplary embodiments of the present invention provide a method for manufacturing a magnetic recording medium including a recording layer having a concavo-convex pattern by using the above methods for forming a concavo-convex pattern.

Various exemplary embodiments of the present invention provide a method for manufacturing a master disk for transferring a concavo-convex pattern by using the above methods for forming a concavo-convex pattern.

The phrase “to process a resin layer supporting member into a concavo-convex pattern” used herein shall mean a case where the resin layer supporting member is divided to be left in convex portions only, a case where the resin layer supporting member is processed into a shape in which the convex portions are partially continuous, and a case where the resin layer supporting member is partially removed in a thickness direction so as to be processed into a shape of a continuous film having both concave portions and convex portions.

The phrase “to etch a resin layer supporting member based on a resin layer” used herein shall mean a case where the resin layer supporting member is etched by using the resin layer that is directly formed on the resin layer supporting member and has a concavo-convex pattern as a mask, and a case where one or more other layers such as a mask layer are formed between the resin layer supporting member and the resin layer and those layers are sequentially etched based on the resin layer having the concavo-convex pattern.

The phrase “1 information on 0 and information on 1” used herein shall mean two kinds of information that are recorded in a recording layer in a binary fashion and have different magnetic properties that can be recognized by a magnetic head in a binary fashion, e.g., information that is given to the recording layer by magnetizing the recording layer and information that is given to the recording layer by leaving the recording layer in a non-magnetized state.

The term “magnetic recording medium” used herein shall mean not only a hard disk, a floppy (registered trademark) disk, a magnetic tape or the like that use magnetism only for recording and reading of information but also a magnetooptical recording medium that uses magnetism and light together, e.g., MO (Magneto Optical) and a heat-assisted recording medium that uses magnetism and heat together.

According to the present invention, it is possible to form a fine and complex concavo-convex pattern such as that corresponding to servo information with high precision.

### BRIEF DESCRIPTION OF THE DRAWINGS

FIG. 1 is a plan view schematically showing the configuration of a magnetic recording medium according to a first exemplary embodiment of the present invention;

FIG. 2 is an enlarged schematic plan view of a servo area of the magnetic recording medium;

FIG. 3 is an enlarged schematic plan view of a basic concavo-convex pattern corresponding to a track address part of the servo area;

FIG. 4 is a further enlarged schematic plan view of the basic concavo-convex pattern corresponding to the track address part;

FIG. 5 is a schematic cross-sectional side view showing the configuration of the magnetic recording medium;

FIG. 6 is a flowchart generally showing a manufacturing process of the magnetic recording medium;

FIG. 7 is a schematic cross-sectional side view showing the configuration and a manufacturing process of a stamper used for manufacturing the magnetic recording medium;

FIG. 8 is a schematic plan view showing a concavo-convex pattern on a transfer surface of the stamper;

FIG. 9 is a schematic cross-sectional side view showing an imprinting process performed by the stamper for a resin layer in an object to be processed;

FIG. 10 is a schematic plan view showing an irregular concavo-convex pattern transferred on the resin layer;

FIG. 11 is a schematic cross-sectional side view of the object to be processed in which a dividing convex portion and the resin layer in bottom of concave portions are removed;

FIG. 12 is a schematic cross-sectional side view of the object to be processed in which a recording layer is processed into a concavo-convex pattern;

FIG. 13 is a schematic plan view showing an irregular concavo-convex pattern transferred on a resin layer according to a second exemplary embodiment of the present invention;

FIG. 14 is a schematic cross-sectional side view showing the configuration of a stamper according to a third exemplary embodiment of the present invention;

FIG. 15 is a schematic plan view showing a concavo-convex pattern of a transfer surface of the stamper;

FIG. 16 is a flowchart generally showing a manufacturing process of the stamper;

FIG. 17 is a schematic cross-sectional side view showing the configuration of a master disk manufactured in the manufacturing process of the stamper;

FIG. 18 is a schematic cross-sectional side view showing a starting structure of an object to be processed for the master disk;

FIG. 19 is a schematic plan view of a basic concavo-convex pattern of a resin layer in the master disk;

FIG. 20 is a schematic plan view of an irregular concavo-convex pattern of the resin layer;

FIG. 21 is a schematic cross-sectional side view showing a state in which the resin layer is processed into a concavo-convex pattern;

FIG. 22 is a schematic cross-sectional side view showing a state in which a mask layer is processed into a concavo-convex pattern;

FIG. 23 is a schematic cross-sectional side view of a master disk in which a conductive film and an electrolytic plating layer are deposited;

FIG. 24 is a flowchart generally showing a manufacturing process of the magnetic recording medium;

FIG. 25 is a schematic cross-sectional side view showing an imprinting process by the stamper;

FIG. 26 is a schematic cross-sectional side view showing the configuration of a master disk for a stamper according to a fourth exemplary embodiment of the present invention;

FIG. 27 is a flowchart generally showing a manufacturing process of the stamper.

FIG. 28 is a schematic plan view of an irregular concavo-convex pattern of a resin layer in a master disk according to fifth and sixth exemplary embodiments of the present invention; and

FIG. 29 is a flowchart generally showing a manufacturing process of a magnetic recording medium according to a seventh exemplary embodiment of the present invention.

### DETAILED DESCRIPTION OF THE PREFERRED EMBODIMENTS

Preferred exemplary embodiments of the present invention will now be described in detail with reference to the drawings.

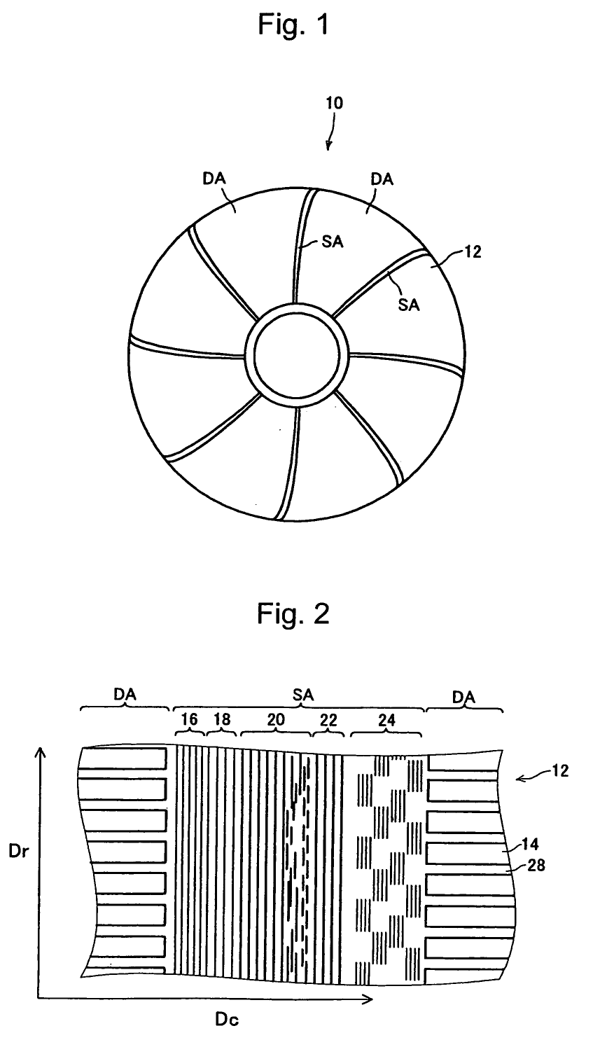

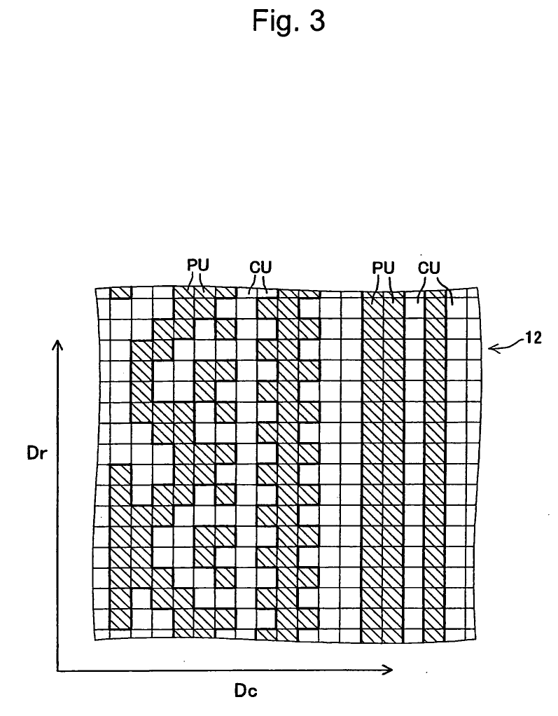

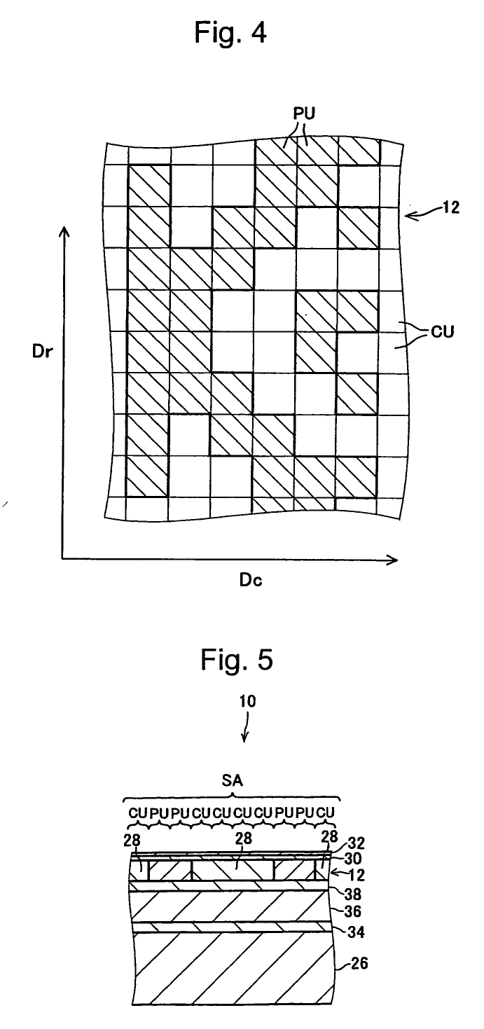

A first exemplary embodiment of the present invention relates to a method for manufacturing a magnetic recording medium 10 sectioned into a plurality of data areas DA and a plurality of servo areas SA, as shown in FIGS. 1 and 2. Each servo area SA is sectioned into a plurality of cell areas in each of which an information on 0 or an information on 1 is recorded in a recording layer 12 in a binary fashion in accordance with a predetermined rule. This manufacturing method includes a step for processing portions of the recording layer 12 in the servo areas SA into a basic concavo-convex pattern shown in FIGS. 3 and 4 or a concavo-convex pattern close to the basic concave-convex pattern. As shown in FIGS. 3 and 4, the basic concavo-convex pattern includes concave unit areas CU that are cell areas for recording one of the information on 0 and the information on 1 therein and a convex unit areas PU that are cell areas for recording the other information therein. In FIGS. 2 to 4, the reference symbol Dc indicates the circumferential direction of the magnetic recording medium 10, and the symbol Dr the radial direction. In FIGS. 3 and 4, cell areas shown with hatching are the convex unit areas PU and other cell areas are the concave unit areas CU.

For understanding of the first exemplary embodiment, the configuration of the magnetic recording medium 10 will be briefly described.

The magnetic recording medium 10 is a perpendicular recording type discrete track medium in the form of a disk. In the magnetic recording medium 10, portions of the recording layer 12 in the data areas DA are divided into concentric arc-like portions, so that a number of recording elements 14 that form tracks and extend along the circumferential direction Dc are formed as convex portions with a predetermined track pitch in the radial direction Dr, as shown in FIG. 2.

Portions of the recording layer 12 in the servo areas SA are formed in the aforementioned basic concavo-convex pattern. Servo information formed in the basic concavo-convex pattern includes a preamble section 16 for synchronization of a clock, a SAM (Servo Address Mark) section 18 indicating the beginning of servo data, a track address signal section 20 indicating a track number, a sector address signal section 22 indicating a sector number, and a burst signal section 24 used for detection of a position of a magnetic head in each recording element (track) 14 in the data areas DA, as shown in FIG. 2. FIGS. 3 and 4 are enlarged views of a part of the track address signal section 20 in the basic concavo-convex pattern. Although the convex portions of the recording layer 12 in the servo area SA are shown as lines parallel to the radial direction Dr in FIG. 2 for convenience of description, the convex portions of the recording layer 12 actually have a width in the circumferential direction Dc, as shown in FIGS. 3 and 4.

The recording layer 12 has a thickness of 5 to 30 nm and is formed over a substrate 26, as shown in FIG. 5. Exemplary materials for the recording layer 12 are CoCr alloys such as a CoCrPt alloy, FePt alloys, laminates of those materials, and materials containing ferromagnetic particles such as CoPt in a matrix in oxide materials such as SiO₂. Exemplary materials for the substrate 26 are glass, Al alloys coated with NiP, Si, and filling materials such as Al₂O₃.

The concave portions between the recording elements 14 in the data areas DA and the concave portions between the convex portions of the recording layer 12 in the servo areas SA are filled with a filling material 28. Examples of the filling material 28 include nonmagnetic materials including oxides such as SiO₂, Al₂O₃, TiO₂, and ferrites, nitrides such as AlN, and carbides such as SiC.

A protective layer 30 and a lubricating layer 32 are formed over the recording layer 12 and the filling material 28 in this order. The protective layer 30 has a thickness of 1 to 5 nm, and is formed of a film of hard carbon called as diamond-like carbon, for example. The lubricating layer 32 has a thickness of 1 to 2 nm. An exemplary material for the lubricating layer 32 is fluorine-based lubricant such as PFPE (perfluoropolyether).

An antiferromagnetic layer 34, a soft magnetic layer 36, and a seed layer 38 for providing magnetic anisotropy in a thickness direction of the recording layer 12 (i.e., a direction perpendicular to a surface) to the recording layer 12 are formed between the substrate 26 and the recording layer 12. The antiferromagnetic layer 34 has a thickness of 5 to 50 nm. Exemplary materials for the antiferromagnetic layer 34 are PtMn alloys and RuMn alloys. The soft magnetic layer 36 has a thickness of 50 to 300 nm. Exemplary materials for the soft magnetic layer 36 are Fe (iron) alloys, Co (cobalt) amorphous alloys, and ferrites. The seed layer 38 has a thickness of 2 to 40 nm. Specific examples of a material for the seed layer 38 are nonmagnetic CoCr alloys, Ti, Ru, laminates of Ru and Ta, and MgO.

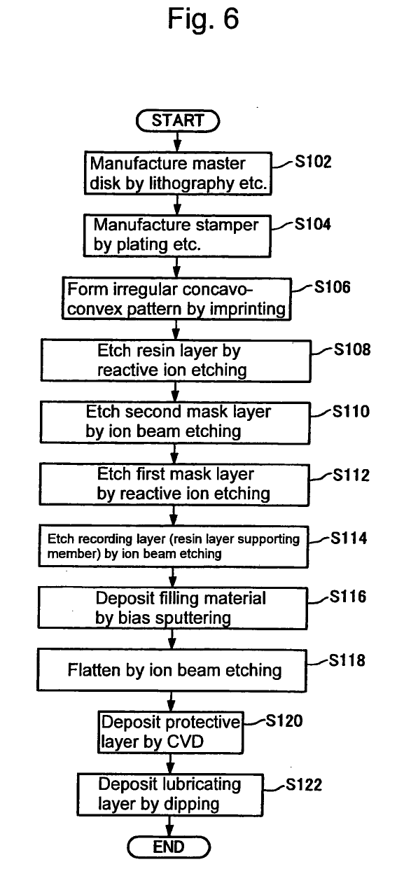

Next, the method for manufacturing the magnetic recording medium 10 will be described based on a flowchart of FIG. 6.

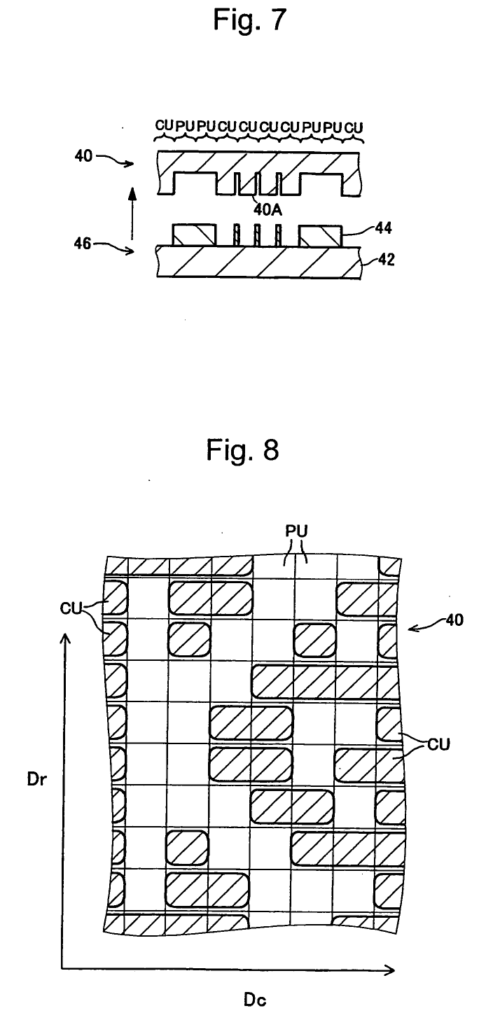

First, a stamper 40 having a transfer surface 40A that has a concavo-convex shape for processing the recording layer 12 into the aforementioned basic concavo-convex pattern, as shown in FIG. 7, is manufactured. More specifically, a positive resist material 44 is applied on a substrate 42 formed of Si, glass or the like. The resist material 44 is exposed with electron beams or the like by a lithography technique, thereby performing drawing. Then, exposed portions of the resist material 44 are removed by development. In this manner, a master disk 46 is manufactured (S102). In the drawing, an irregular concavo-convex pattern is drawn on at least a part of portions of the resist material 44 in the servo areas SA. The irregular concavo-convex pattern is a pattern in which a dividing convex portion is formed in a part of a concave portion of the basic concavo-convex pattern and at least some of concave portions are divided as compared with corresponding concave portions of the basic concavo-convex pattern. The exposure is performed to expose concave portions of the irregular concavo-convex pattern. It is preferable to expose the resist material 44 with an irregular concavo-convex pattern in which the dividing convex portion is formed near a boundary of concave unit areas CU adjoining in the radial direction Dr so as to form concave portions divided in the radial direction Dr in the adjoining concave unit areas CU. By exposing the concave portions of the irregular concavo-convex pattern in which the concave portions are divided as compared with the corresponding concave portions of the basic concavo-convex in the above manner, a range of widths of the exposed portions is limited as compared with the case where exposure is performed in the basic concavo-convex pattern, and a dose in exposure can be adjusted to a value close to an appropriate value for an entire region of the resist material 44. Therefore, the resist material 44 can be processed into the irregular concavo-convex pattern with high precision.

Then, a conductive film (not shown) is deposited on the resist material 44 of the master disk 46 by vapor deposition, electroless plating, or the like and thereafter an electrolytic plating layer of Ni (nickel) or the like is formed by electrolytic plating using the conductive film as an electrode. The conductive film and the electrolytic plating layer are then separated from the master disk as one unit. In this manner, a stamper 40 having a transfer surface 40A with a concavo-convex pattern obtained by reversing the concavo-convex pattern of the master disk 46 is manufactured, as shown in FIGS. 7 and 8 (S104). In FIG. 8, portions shown with hatching are convex portions and other portions are concave portions. In the servo areas SA on the transfer surface 40A of the stamper 40, a concavo-convex pattern is formed in which at least some of convex portion are divided as compared with corresponding convex portions of a reversed basic concavo-convex pattern, in which convex portions are formed in the concave unit areas CU and concave portions are formed in the convex unit areas PU. Please note that the terms “concave unit area CU” and “convex unit area PU” are used based on a concavo-convex pattern to be formed on the recording layer 12. That is, for the concavo-convex pattern of the stamper 40, a concavo-convex relationship is reversed. However, in order to compare the concavo-convex pattern of the stamper 40 with that on the recording layer 12, an area on the stamper 40 corresponding to the concave unit area CU of the recording layer 12 is shown with CU and an area on the stamper 40 corresponding to the convex unit area PU is shown with PU in FIG. 8.

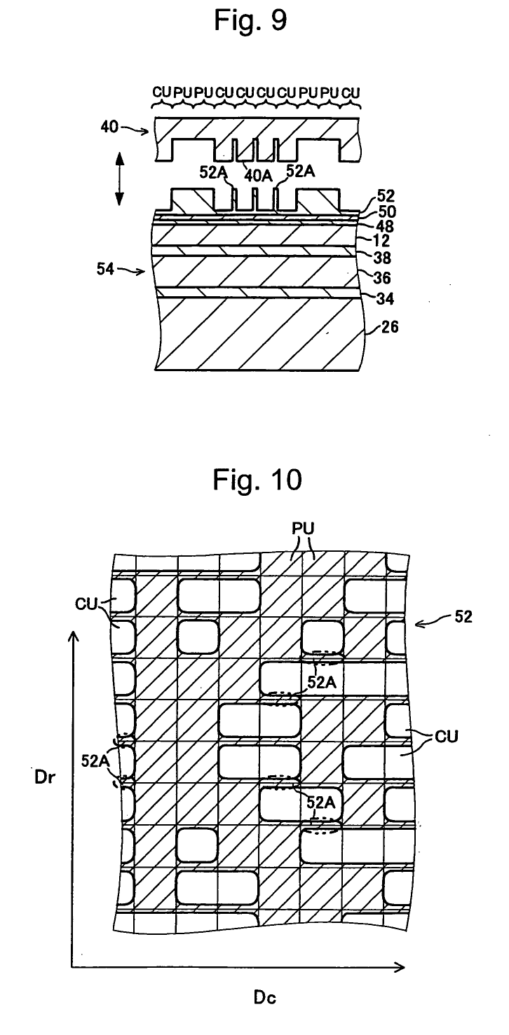

Next, an object to be processed 54 is prepared in which the antiferromagnetic layer 34, the soft magnetic layer 36, the seed layer 38, a recording layer (resin layer supporting member) 12 (that is unprocessed and continuous), a first mask layer 48, a second mask layer 50, and a resin layer 52 are formed over the substrate 26 in that order, as shown in FIG. 9. The concavo-convex pattern of the transfer surface 40A of the stamper 40 is transferred onto the resin layer 52 by bringing the stamper 40 into contact with the resin layer 52. Thus, a concavo-convex pattern containing an irregular concavo-convex pattern shown in FIG. 10 is formed on portions of the resin layer 52 in the servo areas SA. In the irregular concavo-convex pattern, a dividing convex portion 52A is formed in a part of concave portions of the basic concavo-convex pattern and at least some of concave portions are divided as compared with corresponding concave portions of the basic concavo-convex pattern, as shown in FIG. 10 (S106). Here, the first mask layer 48 may be made of C (carbon), and the second mask layer 50 may be made of Ni, for example. The resin layer 52 may be made of a resist material or the like. In FIG. 10, portions shown with hatching are convex portions and other portions are concave portions. Since the widths of the convex portions are suppressed to be small on the transfer surface 40A of the stamper 40, the thickness of the resin layer 52 remaining in the bottom of the concave portions is uniform and thin in the entire region.

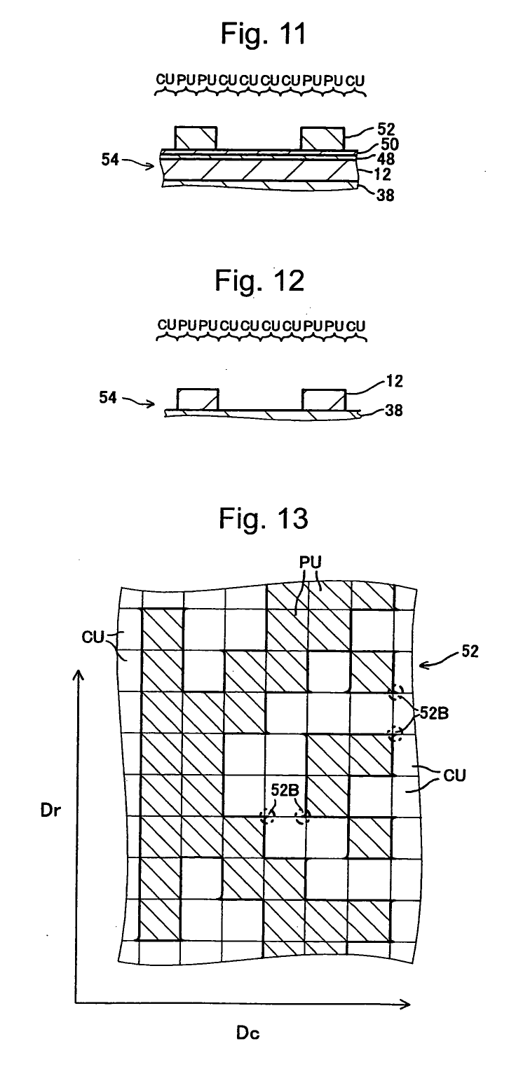

Then, the resin layer 52 is uniformly etched by reactive ion etching using O₂ or O₃ gas to selectively remove the dividing convex portion 52A and remove portions of the resin layer 52 forming the bottom of the concave portions. In this manner, the second mask layer 50 is exposed in the bottom of the concave portions, as shown in FIG. 11 (S108). The dividing convex portion 52A can be removed in a short time because it is smaller in width than the other convex portions. Moreover, since the thickness of the resin layer 52 remaining in the bottom of the concave portions is uniform in the entire region, the portions of the resin layer 52 forming the bottom of the concave portions can be removed in an approximately uniform time in the entire region, thus preventing or sufficiently suppressing occurrence of a variation in the widths of the concave portions. Therefore, portions of the resin layer 52 in the servo areas SA are processed into the basic concavo-convex pattern shown in FIGS. 3 and 4 or a concavo-convex pattern obtained by bringing the irregular concavo-convex pattern close to the basic concavo-convex pattern.

Then, the second mask layer 50 is etched by ion beam etching using Ar gas with the resin layer 52 used as a mask (S110), the first mask layer 22 in the bottom of the concave portions is removed by reactive ion etching using SF₆ gas (S112), and the recording layer 12 in the bottom of the concave portions is removed by ion beam etching using Ar gas (S114). In this manner, the recording layer 12 is processed into a concavo-convex pattern, as shown in FIG. 12. In portions of the recording layer 12 in the servo areas SA, a continuous concave portion is formed under the dividing convex portion 52A. The portions of the recording layer 12 in the servo areas SA are processed into the basic concavo-convex pattern shown in FIGS. 3 and 4 or a concavo-convex pattern obtained by bringing the irregular concavo-convex pattern close to the basic concavo-convex pattern.

Then, the filling material 28 is deposited on the recording layer 12 by bias sputtering to fill the concave portions (S116) and thereafter an excess part of the filling material 28 is removed by ion beam etching in which Ar gas is made incident from a direction inclined with respect to the surface of the recording layer 12. In this manner, the surface of the recording layer 12 and filling material 28 is flattened (S118).

Then, the protective layer 30 is deposited on the upper surface of the recording layer 12 and the filling material 28 by CVD (S120) and the lubricating layer 32 is formed on the protective layer 30 by dipping (S122). In this manner, the magnetic recording medium 10 is completed.

As described above, the recording layer 12 can be processed into the basic concavo-convex pattern or a concavo-convex pattern close to the basic concavo-convex pattern by processing the resin layer 52 into an irregular concavo-convex pattern in which a dividing convex portion 52A is formed in a part of concave portions of the basic concavo-convex pattern and at least some of concave portions are divide as compared with corresponding concave portions of the basic concavo-convex pattern, etching the resin layer 52 to selectively remove the dividing convex portion 52A, and sequentially etching the second mask layer 50, the first mask layer 48, and the recording layer 12 based on the resin layer 52.

Since portions of the recording layer 12 in the servo areas SA of the magnetic recording medium 10 are formed in the basic concavo-convex pattern on which the servo information is reflected, the servo information can be recorded by application of a DC magnetic field efficiently and surely. More specifically, when each convex portion in the servo areas SA is magnetized in a predetermined direction perpendicular to the surface, one of the information on 0 and the information on 1 is recorded in that convex portion. When each convex portion is not magnetized, the other information is recorded in that convex portion.

In some cases, a part of the dividing convex portions 52A of the resin layer 52, a part of corresponding convex portions of the second mask layer 50 and the first mask layer 48 are not completely removed before the etching step of the recording layer 12 (S114) and therefore the recording layer 12 is processed into a concavo-convex pattern in which a slightly convex portion is formed in a part of a portion corresponding to concave portion of the basic concavo-convex pattern. However, when the dividing convex portion 52A is formed near a boundary of adjoining concave unit areas CU, the concave portions of the recording layer 12 are divided for every concave unit area CU. Thus, the magnetic head can precisely recognize the respective concave unit areas with ease. Moreover, even if a convex portion is formed near the boundary of the concave unit areas CU adjoining in the radial direction Dr, its effect on reading of a servo signal is small because the magnetic head travels above the magnetic recording medium 10 in the circumferential direction Dc relatively. In other words, it is preferable that the resin layer 52 be processed into an irregular concavo-convex pattern in which concave portions are divided in the radial direction Dr as compared with corresponding concave portions of the basic concavo-convex pattern.

A second exemplary embodiment of the present invention will now be described.

The second exemplary embodiment has a feature that, unlike the first exemplary embodiment, the resin layer 52 is processed into an irregular concavo-convex pattern shown in FIG. 13 in which some corners of convex portions projecting toward adjacent concave portions have projections that project more toward the adjacent concave portions as compared with corresponding corners of the basic concavo-convex pattern in the irregular concavo-convex pattern formation step (S106).

When the resin layer 52 is processed into that irregular concavo-convex pattern, the projections 52B of the resin layer 52 and projections of corresponding corners of convex portions of the second mask layer 50 and the first mask layer 48 are removed in the resin layer etching step (S108), the second mask layer etching step (S110), and the first mask layer etching step (S112). Therefore, those corners are processed into a shape close to corresponding corners of the basic concavo-convex pattern. That is, the resin layer 52, the second mask layer 50, and the first mask layer 48 are processed into the basic concavo-convex pattern or a concavo-convex pattern close to the basic concavo-convex pattern. By etching the recording layer 12 based on the resin layer 52, the second mask layer 50, and the first mask layer 48 that are processed in the above manner, it is possible to process the recording layer 12 into the basic concavo-convex pattern or a concavo-convex pattern close to the basic concavo-convex pattern. In order to improve process precision of the recording layer 12, it is preferable that an inner angle of the projection 52B be an acute angle.

A third exemplary embodiment of the present invention is now described.

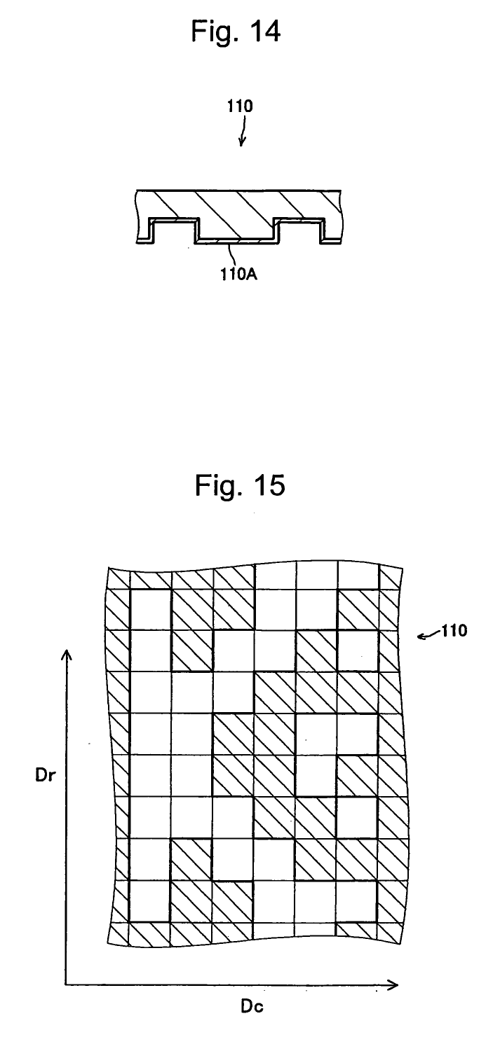

The third exemplary embodiment relates to a method for manufacturing a master disk 140 shown in FIG. 17, a method for manufacturing a stamper 110 having a transfer surface 110A with a concavo-convex pattern shown in FIGS. 14 and 15 by using the master disk 140, and a method for manufacturing the magnetic recording medium 10 shown in FIGS. 1 and 2 by using the stamper 110.

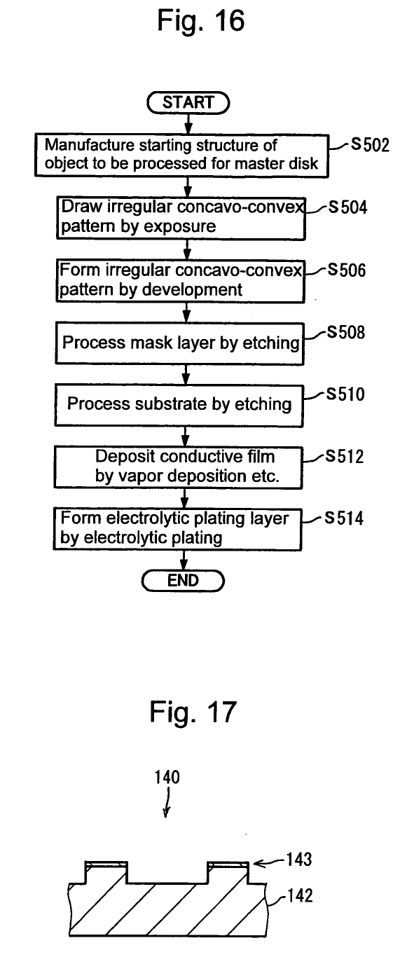

The method for manufacturing the stamper 110 will be described based on a flowchart shown in FIG. 16.

First, the master disk 140 shown in FIG. 17 is manufactured. The master disk 140 includes a substrate 142 having one side processed into a concavo-convex pattern and a mask layer 143 formed on convex portions of the substrate 142. The substrate 142 is formed of Si and the mask layer 143 is formed of Ni.

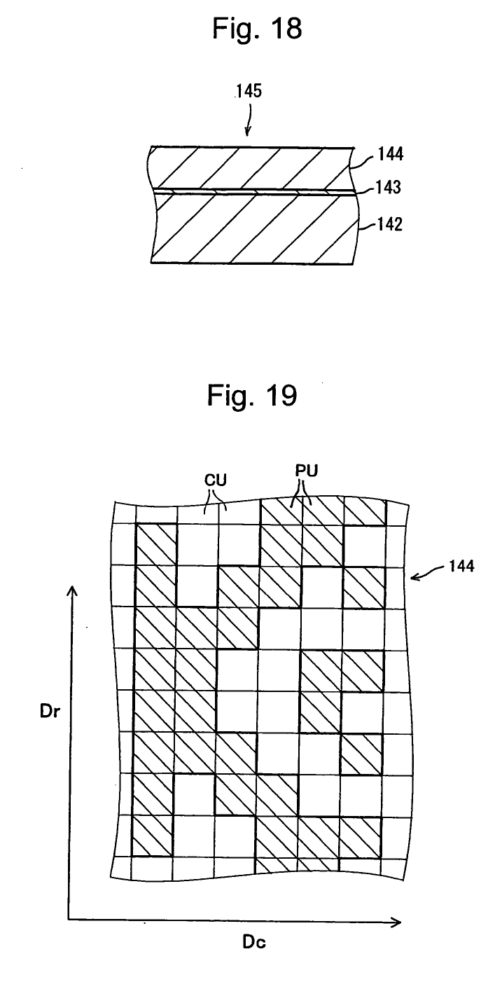

First, the substrate (resin layer supporting member) 142 in which both sides are flat and unprocessed is cleaned. Then, the mask layer 143 is deposited on one side of the substrate 142 to have a uniform thickness by sputtering or the like and a thin layer (not shown) serving as an adhesion member is further formed. Then, a resin layer 144 is formed by spin coating. In this manner, a starting structure of an object to be processed 145 for the master disk is manufactured, as shown in FIG. 18 (S502). The resin layer 144 is made of a positive resist material. Solvent in the resin layer 144 is then vaporized and dried by baking, and thereafter a thickness of the resin layer 144 and presence or absence of a defect in the resin layer 144 are checked.

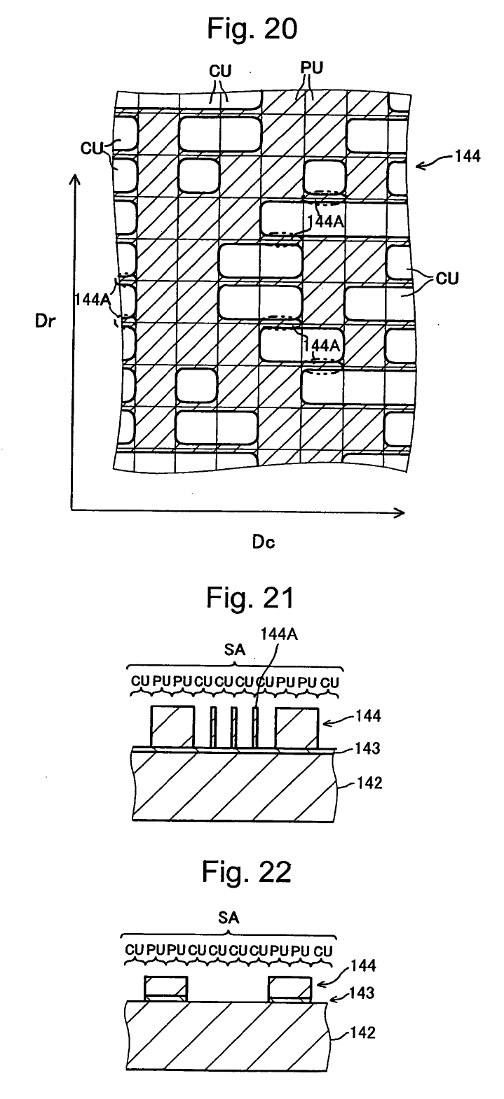

Then, the resin layer 144 is irradiated with laser beams or electron beams, thereby performing drawing of an exposure pattern corresponding to an irregular concavo-convex pattern shown in FIG. 20 (S504). In the irregular concavo-convex pattern, a dividing convex portion 144A are formed in a part of concave portions of a basic concavo-convex pattern that is shown in FIG. 19 and corresponds to the concavo-convex pattern of the transfer surface 110A of the stamper 110, and at least some concave portions are divided as compared with corresponding concave portions of the basic concavo-convex pattern. In FIGS. 19 and 20, portions shown with hatching are convex portions and other portions are concave portions.

In the basic concavo-convex pattern, cell areas in the servo areas of the recording layer 12, in which either one of an information on 0 and an information on 1 is recorded, is concave unit areas CU, and cell areas in which the other information is recorded are convex unit areas PU.

On the other hand, in the irregular concavo-convex pattern, the dividing convex portion 144A is arranged near a boundary of at least two adjoining concave unit areas CU of the basic concavo-convex pattern and a concave portion is divided as compared with corresponding concave portion located in those concave unit areas CU. It is preferable that the irregular concavo-convex pattern be a pattern in which the dividing convex portion 144A is formed near a boundary of at least two concave unit areas CU adjoining in the radial direction Dr and concave portions divided in the radial direction Dr are formed in those adjoining concave unit areas CU.

Then, exposed portions of the resin layer 144 are removed by development, so that the resin layer 144 is processed into the irregular concavo-convex pattern shown in FIG. 20 (S506). When portions of the resin layer 144 that correspond to the concave portions of the irregular concavo-convex portion in which at least some of concave portions are divided as compared with corresponding concave portions of the basic concavo-convex pattern are exposed, a range of the widths of the exposed portions is limited as compared with the case where portions of the resin layer 144 corresponding to the concave portions of the basic concavo-convex pattern are exposed. Thus, a dose in exposure can be adjusted to be a value close to an appropriate value for the entire region of the resin layer 144. Therefore, the resin layer 144 can be processed into the irregular concavo-convex pattern with high precision, as shown in FIGS. 20 and 21.

The mask layer 143 is then etched by ion beam etching using Ar gas as a processing gas (S508).

In this etching, the convex portions of the resin layer 144 are also etched. Since the dividing convex portions 144 are significantly smaller in width than another convex portions of the resin layer 144 and are removed faster than the other convex portions, the resin layer 144 is etched in such a manner that continuous concave portions are formed in regions corresponding to the dividing convex portions 144A. That is, the resin layer 144 is processed into the basic concavo-convex pattern or a concavo-convex pattern obtained by bringing the irregular concavo-convex pattern close to the basic concavo-convex pattern. Therefore, the mask layer 143 is also processed into the basic concavo-convex pattern or a concavo-convex pattern obtained by bringing the irregular concavo-convex pattern close to the basic concavo-convex pattern, as shown in FIG. 22. After the mask layer 143 is processed, the resin layer 144 on the convex portions is removed by reactive ion etching using O₂ or O₃ gas as a reactive gas.

Then, the substrate 142 is etched by reactive ion etching using fluorine-based gas as a reactive gas so as to be processed into the basic concavo-convex pattern or a concavo-convex pattern obtained by bringing the irregular concavo-convex pattern close to the basic concavo-convex pattern (S510). In this manner, the master disk 140 shown in FIG. 17 is obtained.

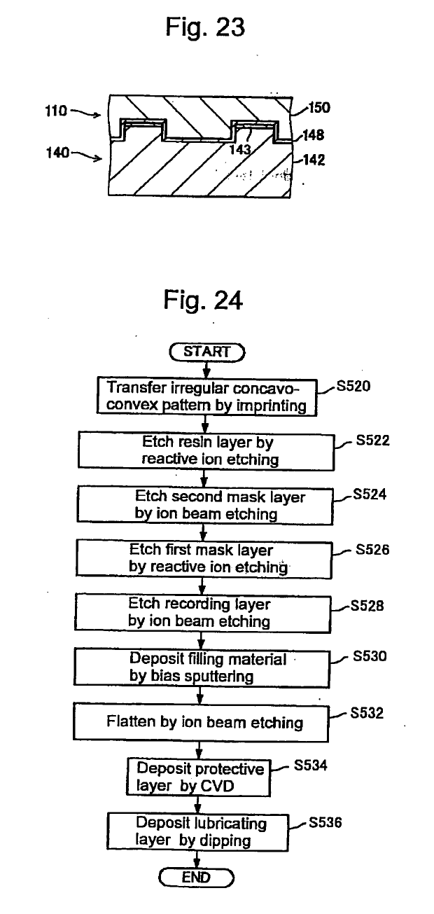

A conductive film 148 is then formed on a surface of the master disk 140 by vapor deposition, electroless plating, or the like (S512), and an electrolytic plating layer 150 is formed on the conductive film 148 by electrolytic plating (S514), as shown in FIG. 23. More specifically, the master disk 140 with the conductive film 148 formed thereon is immersed in a nickel sulfamate solution and a current is applied to the conductive film 148 as an electrode. In this manner, a layer of nickel is made to grow, so that the electrolytic plating layer 150 is formed. The conductive film 148 and the electrolytic plating layer 150 are then separated as one unit from the master disk 140. In some cases, the resin layer 144 adheres to the conductive film 148 and the electrolytic plating layer 150 thus separated. Therefore, the resin layer 144 is removed by organic solvent, an outer circumference of the conductive film 148 and electrolytic plating layer 150 is punched out to make their shapes better, if necessary, and a surface of the electrolytic plating layer 150 that is opposite to the conductive film 148 is polished and then cleaned with ultrapure water by ultrasonic cleaning. In this manner, the stamper 110 having the transfer surface 110A with the concavo-convex pattern shown in FIG. 15 is obtained. Please note that the concavo-convex pattern on the transfer surface 110A of the stamper 110 is a reversed pattern of the concavo-convex pattern of the master disk 140.

As described above, the substrate 142 can be processed by performing drawing for the resin layer 144 to expose portions of the resin layer 144 corresponding to the concave portions of the irregular concavo-convex pattern; removing the exposed portion of the resin layer 144 by development to process the resin layer 144 into the irregular concavo-convex pattern; etching the mask layer 143 and etching the resin layer 144 to remove at least a part portions of the mask layer 143 corresponding to the dividing convex portions 144A, thereby processing the mask layer 143 into the basic concavo-convex pattern or a concavo-convex pattern obtained by bringing the irregular concavo-convex pattern close to the basic concavo-convex pattern; and etching the substrate 142 based on the mask layer 143. As a result, the substrate 142 can be processed with high precision into the basic concavo-convex pattern that corresponds to the concavo-convex pattern of the transfer surface 110A of the stamper 110 or a pattern obtained by bringing the irregular concavo-convex pattern in which the dividing convex portion 144A is formed in a part of concave potions of the basic concavo-convex pattern and concave portions are divided as compared with corresponding concave portions of the basic concavo-convex pattern close to the basic concavo-convex pattern.

Next, a method for manufacturing the magnetic recording medium 10 that uses the stamper 110 will be described based on a flowchart shown in FIG. 24.

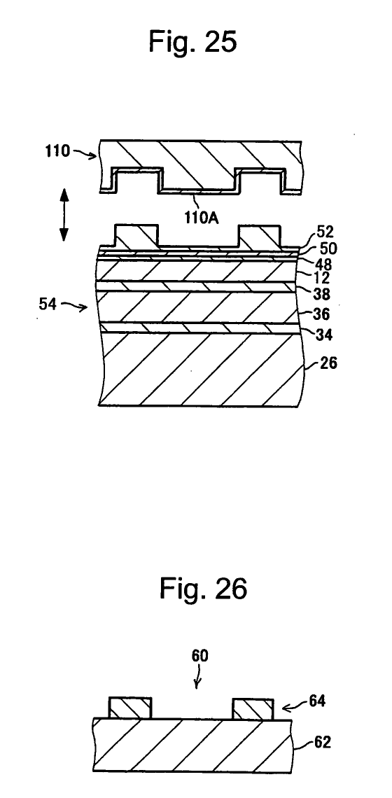

First, the starting structure of the object to be processed 54 for the magnetic recording medium, as shown in FIG. 25, that is the same as that in the first exemplary embodiment is prepared. The concavo-convex pattern of the transfer surface 110A of the stamper 110 is transferred onto the resin layer 52 by bringing the stamper 110 into contact with the resin layer 52. Thus, a reversed pattern of the concavo-convex pattern of the transfer surface 110A is formed on the resin layer 52 (S520). This reversed pattern has the same concavo-convex relationship as the concavo-convex pattern of the master disk 140.

Then, the resin layer 52 is uniformly etched by reactive ion etching using O₂ or O₃ gas to such an extent that portions of the resin layer 52 forming bottom of the concave portions is removed, thereby exposing the second mask layer 50 in the bottom of the concave portions (Step S522). Portions of the resin layer 52 in the servo areas SA are processed into the basic concavo-convex pattern shown in FIG. 19 or a concavo-convex pattern obtained by bringing the irregular concavo-convex pattern close to the basic concavo-convex pattern.

The second mask layer 50 is then etched with the resin layer 52 used as a mask by ion beam etching using Ar gas (S524), the first mask layer 48 in the bottom of the concave portions is removed by reactive ion etching using SF₆ gas (S526), and the recording layer 12 in the bottom of the concave portions is removed by ion beam etching using Ar gas (S528). In this manner, the recording layer 12 is processed into the concavo-convex pattern shown in FIGS. 2 to 4. Portions of the recording layer 12 in the servo areas SA are processed into the basic concavo-convex pattern shown in FIGS. 3 and 4 or a concavo-convex pattern obtained by bringing the irregular concavo-convex pattern close to the basic concavo-convex pattern.

The filling material 28 is then deposited on the recording layer 12 by bias sputtering to fill the concave portions (S530) and thereafter an excess part of the filling material 28 is removed by ion beam etching in which Ar gas is made incident from a direction inclined with respect to the surface of the recording layer 12, so as to flatten the surface of the recording layer 12 and the filling material 28 (S532).

The protective layer 30 is then deposited on the upper surface of the recording layer 12 and the filling material 28 by CVD (S534) and the lubricating layer 32 is deposited on the protective layer 30 by dipping (S536). In this manner, the magnetic recording medium 10 is completed.

In manufacturing of the master disk 140, the dividing convex portion 144A of the resin layer 144 may not be completely removed in the mask layer etching step (S508). In this case, the recording layer 12 may be processed into a concavo-convex pattern in which a concave portion of a desired concavo-convex pattern is partially divided. However, if the resin layer 144 is processed into an irregular concavo-convex pattern in which the dividing convex portion 144A is formed near a boundary of adjoining concave unit areas CU, the recording layer 12 is processed so as to divide concave portions for every cell area sectioning the servo areas SA. Thus, the magnetic head can precisely recognize each cell area with ease. Moreover, when the resin layer 144 is processed into an irregular concavo-convex pattern in which the dividing convex portion 144A is formed near a boundary of concave unit areas CU adjoining in the radial direction Dr, its effect on reading of a servo signal is small because the magnetic head travels above the magnetic recording medium 10 relatively in the circumferential direction Dc. In other words, it is preferable also in the third exemplary embodiment to process the resin layer 144 into the irregular concavo-convex pattern in which at least some of concave portions are divided in the radial direction Dr as compared with corresponding concave portions of the basic concavo-convex pattern.

A fourth exemplary embodiment of the present invention is now described.

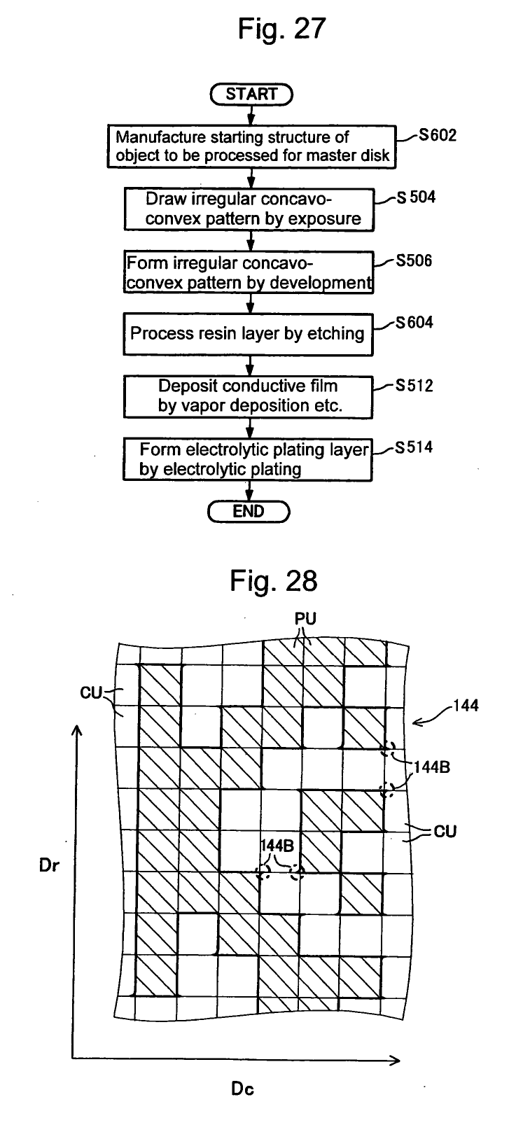

The master disk 140 of the third exemplary embodiment includes the substrate 142 having one side processed into a concavo-convex pattern and the mask layer 143 formed on the convex portions of the substrate 142, whereas a master disk 160 of the fourth exemplary embodiment includes a substrate 162 in which both sides are flat and a resin layer 164 formed in a concavo-convex pattern on the substrate 162, as shown in FIG. 26. In a manufacturing step of the master disk 160, no mask layer is formed between the substrate 162 and the resin layer 164 and the mask layer processing step (S508) and the substrate processing step (S510) are omitted. Instead, a resin layer etching step (S604) is provided between the development step (S506) and the conductive film deposition step (S512), as shown in a flowchart of FIG. 27. Except for the above, the fourth exemplary embodiment is the same as the third exemplary embodiment and therefore the description of the fourth exemplary embodiment is omitted in an appropriate manner.

A method for manufacturing the master disk 160 is specifically described. First, a starting structure of an object to be processed for the master disk, in which the resin layer 164 is formed on the substrate 162 to have a uniform thickness, is manufactured (S602). The exposure step (S504) and the development step (S506) are then performed to process the resin layer 164 into an irregular concavo-convex pattern, as in the third exemplary embodiment.

The resin layer 164 is then etched to selectively remove dividing convex portions of the resin layer 164. In this manner, the resin layer 164 is processed into the basic concavo-convex pattern or a concavo-convex pattern obtained by bringing the irregular concavo-convex pattern close to the basic concavo-convex pattern (S604). More specifically, reactive ion etching using O₂ or O₃ gas as a reactive gas, ion beam etching using Ar gas or O₂ or O₃ gas, or the like can be used in the above etching. In this manner, the master disk 160 shown in FIG. 26 is obtained.

The conductive film deposition step (S512) and the electrolytic plating step (S514) are performed for the master disk 160 thus obtained in the same manner as that in the third exemplary embodiment, thereby obtaining the stamper 110. In the fourth exemplary embodiment, it is also possible to form, with high precision, the basic concavo-convex pattern or a concavo-convex pattern obtained by bringing the irregular concavo-convex pattern close to the basic concavo-convex pattern on the transfer surface 110A of the stamper 110 as in the third exemplary embodiment.

A fifth exemplary embodiment of the present invention will now be described.

In the irregular concavo-convex pattern in the third exemplary embodiment, the dividing convex portions 144A are formed in a part of concave portions of the basic concavo-convex pattern and concave portions are divided as compared with corresponding concave portion of the basic concavo-convex pattern. Unlike the irregular concavo-convex pattern in the third exemplary embodiment, an irregular concavo-convex pattern in this fifth exemplary embodiment has a feature that at least some of corners of convex portions that respectively project toward their adjacent concave portions have projections 144B that project more toward adjacent concave portions as compared with corresponding corners of the basic concavo-convex pattern, as shown in FIG. 28. Except for the above, the fifth exemplary embodiment is the same as the third exemplary embodiment and therefore the description of the fifth exemplary embodiment is omitted.

The resin layer 144 is processed into a concavo-convex pattern corresponding to that irregular concavo-convex pattern by performing the step for manufacturing the starting structure of the object to be processed (S502), the exposure step (S504) and the development step (S506) in the same manner as that in the third exemplary embodiment.

Subsequently, when the mask layer 143 is etched (S508), the resin layer 144 is also etched. In this etching, the projections 144B of the resin layer 144 are etched faster than other portions thereof and the corners having the projections 144B are processed in a shape close to those of the corresponding corners of the basic concavo-convex pattern. In other words, the resin layer 144 is processed into the basic concavo-convex pattern or a concavo-convex pattern obtained by bringing the irregular concavo-convex pattern close to the basic concavo-convex pattern. Therefore, the mask layer 143 is also processed in the basic concavo-convex pattern or a concavo-convex pattern obtained by bringing the irregular concavo-convex pattern close to the basic concavo-convex pattern. It is preferable that an inner angle of the projections 144B be an acute angle in order to process the resin layer 144 into a concavo-convex pattern close to the basic concavo-convex pattern.

Then, the substrate 142 is etched (S510). Thus, the substrate 142 is also processed into the basic concavo-convex pattern or a concavo-convex pattern obtained by bringing the irregular concavo-convex pattern close to the basic concavo-convex pattern.

The stamper 110 is obtained by performing the conductive film deposition step (S512) and the electrolytic plating step (S514) for the master disk 140 in the same manner as that in the first exemplary embodiment. In the fifth exemplary embodiment, it is also possible to form the basic concavo-convex pattern or a concavo-convex pattern obtained by bringing the irregular concavo-convex pattern close to the basic concavo-convex pattern on the transfer surface 110A of the stamper 110 with high precision, as in the first exemplary embodiment.

A sixth exemplary embodiment of the present invention is now described.

In the sixth exemplary embodiment, the irregular concavo-convex pattern in the fifth exemplary embodiment shown in FIG. 28 is used in the fourth exemplary embodiment. Except for the above, the sixth exemplary embodiment is the same as the third to fifth exemplary embodiments and therefore the description of the sixth exemplary embodiment is omitted in an appropriate manner. In the sixth exemplary embodiment, it is also possible to form the basic concavo-convex pattern or a concavo-convex pattern obtained by bringing the irregular concavo-convex pattern close to the basic concavo-convex pattern on the transfer surface 110A of the stamper 110 with high precision, as in the third to fifth exemplary embodiments.

In the first exemplary embodiment, the basic concavo-convex pattern shown in FIGS. 3 and 4 is described as an exemplary basic concavo-convex pattern of the recording layer 12 in the servo areas SA, and the irregular concavo-convex pattern shown in FIG. 10 is described as an exemplary irregular concavo-convex pattern of the resin layer 52 corresponding to the above basic concavo-convex pattern. Moreover, in the second exemplary embodiment, the irregular concavo-convex pattern shown in FIG. 13 is described as an exemplary irregular concavo-convex pattern of the resin layer 52. However, the basic concavo-convex pattern of the recording layer and the irregular concavo-convex pattern of the resin layer can be determined in an appropriate manner in accordance with a required performance and the like.

This is the same for the irregular concavo-convex pattern of the resin layer 144 in the third and fourth exemplary embodiments shown in FIG. 20 and that in the fifth and sixth exemplary embodiments shown in FIG. 28.

For example, FIG. 2 shows the servo information containing the preamble section 16, the SAM section 18, the track address signal section 20, the sector address signal section 22, and the burst signal section 24 as an example. However, the servo information may have a structure in which those sections are partially interchanged, one or more of those sections are omitted, or a section having another function is added, in accordance with a required performance and the like. The basic concavo-convex pattern of the recording layer or the master disk and the irregular concavo-convex pattern of the resin layer are determined in accordance with the above-described servo information in an appropriate manner.

The cell areas sectioning the servo areas SA are not limited to a square or a rectangle in which an inner angle is a right angle, but may be a parallelogram.

In FIG. 10 of the first exemplary embodiment, the irregular concavo-convex pattern of the resin layer 52 is a pattern in which the dividing convex portions 52A are formed at every boundary of all concave unit areas CU adjoining in the radial direction Dr in the basic concavo-convex pattern and concave portions are divided in the radial direction Dr for all the concave unit areas CU. Alternatively, the resin layer 52 may be processed into another irregular concavo-convex pattern in which the dividing convex portions 52A are formed at boundaries of some of the concave unit areas CU adjoining in the radial direction Dr in the basic concavo-convex pattern and some concave portions are divided as compared with corresponding concave portions of the basic concavo-convex pattern, as long as the recording layer 12 can be processed into a concavo-convex pattern that is close to the basic concavo-convex pattern to such an extent that good reproduction of the servo information is ensured.

This is the same for the irregular concavo-convex pattern of the resin layer 144 of the third and fourth exemplary embodiments shown in FIG. 20.

In FIG. 10 of the first exemplary embodiment, the irregular concavo-convex pattern of the resin layer 52 is a pattern in which the dividing convex portions are formed near the boundary of the concave unit areas CU adjoining in the radial direction Dr so as to form concave portions divided in the radial direction Dr in those adjoining concave unit areas CU. Alternatively, the resin layer 52 may be processed into another irregular concavo-convex pattern in which the dividing convex portions 52A are formed at portions that are not near the boundaries of the concave unit areas CU in the basic concavo-convex pattern and concave portions are divided in the radial direction Dr as compared with corresponding concave portions of the basic concavo-convex pattern, as long as the recording layer 12 can be processed into a concavo-convex pattern close to the basic concavo-convex pattern to such an extent that the magnetic head can surely recognize each concave unit area CU as a concave portion. Moreover, the resin layer 52 may be processed into still another irregular concavo-convex pattern in which the concave portions are divided in the circumferential direction Dc as compared with corresponding concave portions of the basic concavo-convex pattern, as long as the recording layer 12 can be processed into a concavo-convex pattern that is close to the basic concavo-convex pattern to such an extent that the magnetic head can surely recognize each concave unit area CU as a concave portion.

This is the same for the irregular concavo-convex pattern of the resin layer 144 in the third and fourth exemplary embodiments shown in FIG. 20.

In the first exemplary embodiment, the dividing convex portions 52A of the resin layer 52 are completely removed in the resin layer etching step (S108). Alternatively, the dividing convex portions 52A may be partially removed in the resin layer etching step (S108) and then etching of the second mask layer 50 and complete removal of the dividing convex portions 52A may be performed in the second mask layer etching step (S110). In this case, it is preferable to process the second mask layer 50 so as not to form convex portions in regions corresponding to the dividing convex portions 52A. Incidentally, in the case where the dividing convex portions 52A of the resin layer 52 are not completely removed in the resin layer etching step (S108), not only the dividing convex portions 52A are left but also convex portions are formed in regions of the second or first mask layer 50 or 48 corresponding to the dividing convex portions 52A in some cases. However, in those cases, the dividing convex portions 52A of the resin layer 52 and the thus formed convex portions of the second or first mask layer 50 or 48 are removed during sequential etching of the second mask layer 50, the first mask layer 48, and the recording layer 12 based on the resin layer 52. For example, in the first mask layer etching step (S112), the first mask layer 48 may be etched while the dividing convex portions 52A of the resin layer 52 and/or the convex portions of the second mask layer 50 corresponding thereto are completely removed. In this case, it is preferable to process the first mask layer 48 so as not to form convex portions in regions corresponding to the dividing convex portions 52A.

On the other hand, in the third and fifth exemplary embodiments, during etching of the mask layer 143 by using the resin layer 144 as mask, the mask layer 143 is processed into a concavo-convex pattern obtained by bringing the irregular concavo-convex pattern close to the basic concavo-convex pattern while the resin layer 144 is processed into a concavo-convex pattern obtained by bringing the irregular concavo-convex pattern close to the basic concavo-convex pattern. Alternatively, a resin layer etching step may be provided between the development step (S506) and the mask layer etching step (S508), so that the resin layer 144 is processed into the concavo-convex pattern obtained by bringing the irregular concavo-convex pattern close to the basic concavo-convex pattern in that resin layer etching step.

In addition, the dividing convex portions 144A of the resin layer 144 and portions of the mask layer 143 corresponding to the dividing convex portions 144A may not be completely removed to remain after the mask layer etching step (S508). In this case, the dividing convex portions 144A of the resin layer 144 and the corresponding convex portions of the mask layer 143 are removed in the substrate etching step (S510).

In the first exemplary embodiment, the dividing convex portions 52A of the resin layer 52 are completely removed and the recording layer 12 is processed to form continuous concave portions under the dividing convex portions 52A. Alternatively, the recording layer 12 may be processed into a concavo-convex pattern close to the basic concavo-convex pattern, e.g., a pattern in which some of the concave portions are divided as compared with corresponding concave portions of the basic concavo-convex pattern or a pattern in which a slightly convex portions are formed under the dividing convex portions 52A, as long as the magnetic head can surely recognize each concave unit area CU as a concave portion.

Similarly, the substrate 142 is etched to form continuous concave portions in regions corresponding to the dividing convex portions 144A in the third exemplary embodiment, and the resin layer 144 is etched to form continuous concave portions in regions corresponding to the dividing convex portions 144A in the fourth exemplary embodiment. Alternatively, the substrate 142 or the resin layer 144 may be processed into a concavo-convex pattern close to the basic concavo-convex pattern, e.g., a pattern in which slightly convex portions are formed in regions corresponding to the dividing convex portions 144A, as long as the magnetic head can surely recognize information indicative of 0 or 1.

In FIG. 13 of the second exemplary embodiment, the irregular concavo-convex pattern of the resin layer 52 is a pattern in which every corner of convex portions projecting toward the adjacent concave portions has the projection 52B that projects more toward the adjacent concave portion as compared with a corresponding corner of the basic concavo-convex pattern. Alternatively, an irregular concavo-convex pattern may be employed in which some of the corners of the convex portions projecting toward their adjacent concave portions have the projections that project more toward their adjacent concave portions as compared with the corresponding corners of the basic concave-convex pattern, as long as the recording layer 12 can be processed into the basic concavo-convex pattern or a desired concavo-convex pattern close to the basic concavo-convex pattern.

Similarly, in FIG. 28 of the fifth and sixth exemplary embodiments, the irregular concavo-convex pattern of the resin layer 144 is a pattern in which every corner of convex portions projecting toward adjacent concave portions has the projection 144B projecting more toward its adjacent concave portion as compared with a corresponding corner of the basic concavo-convex pattern. Alternatively, an irregular concavo-convex pattern may be employed in which some of the corners of the convex portions projecting toward their adjacent concave portions, respectively, have the projections that project more toward their adjacent concave portions as compared with the corresponding corners of the basic concave-convex pattern, as long as the basic concavo-convex pattern or a desired concavo-convex pattern close to the basic concavo-convex pattern can be formed on the master disk 140 or 160.

Moreover, the irregular concavo-convex pattern of the resin layer 52 is a pattern in which the concave portions are divided in the radial direction Dr as compared with corresponding concave portions of the basic concavo-convex pattern of the recording layer 12 in the first exemplary embodiment, and is a pattern in which the corners of the convex portions projecting toward the adjacent concave portion have the projections 52B that project more as compared with corresponding corners of the basic concavo-convex pattern of the recording layer 12 in the second exemplary embodiment. Alternatively, the resin layer 52 may be processed into another irregular concavo-convex pattern in which some of concave portions are divided as compared with corresponding concave portions of the basic concavo-convex pattern and some of the corners of the convex portions each projecting toward the adjacent concave portions have the projections that project toward the adjacent concave portions more as compared with corresponding corners of the basic concavo-convex pattern.

Similarly, the irregular concavo-convex pattern of the resin layer 144 is a pattern in which the concave portions are divided as compared with corresponding concave portions of the basic concavo-convex pattern in the third and fourth exemplary embodiments, and is a pattern in which the corners of the convex portions projecting toward the adjacent concave portions have the projections that project more as compared with corresponding corners in the basic concavo-convex pattern in the fifth and sixth exemplary embodiments. Alternatively, those two patterns may be combined, so that the resin layer 144 is processed into an irregular concavo-convex pattern in which some of the concave portions are divided as compared with corresponding concave portions of the basic concavo-convex pattern and some of the corners of the convex portions projecting toward the adjacent concave portions have the projections projecting more than the corresponding corners of the basic concavo-convex pattern.

Moreover, FIG. 10 of the first exemplary embodiment and FIG. 13 of the second exemplary embodiment are enlarged views of the track address signal section 20 of the resin layer 52 in the servo areas SA. Areas in which the resin layer is processed into the irregular concavo-convex pattern may be the entire servo areas SA or may be limited to areas in which a fine and complex concavo-convex pattern should be formed, e.g., the track address signal part 20.

Similarly, FIG. 20 of the third and fourth exemplary embodiments and FIG. 28 of the fifth and sixth exemplary embodiments are enlarged views of a portion of the resin layer 144 corresponding to the track address signal section 20 in the servo area SA. An area in which the resin layer is processed into the irregular concavo-convex pattern may be the entire servo area SA or may be limited to an area in which a fine and complex concavo-convex pattern should be formed, e.g., the track address signal section 20.

In the first exemplary embodiment, the object to be processed 54 has a structure in which the first mask layer 48, the second mask layer 50, and the resin layer 52 are formed over the recording layer 12, and the recording layer 12 is processed into the basic concavo-convex pattern or a concavo-convex pattern close to the basic concavo-convex pattern by sequentially etching those layers 48, 50, and 52. However, the material, the thickness and the number of mask layers between the recording layer and the resin layer are not specifically limited, as long as the recording layer can be processed into the basic concavo-convex pattern or the concavo-convex pattern close to the basic concavo-convex pattern with high precision. For example, a single mask layer may be provided between the recording layer and the resin layer. Alternatively, three or more mask layers may be provided. Moreover, the resin layer may be directly formed on the recording layer. This is the same for the second to sixth exemplary embodiments.

In the third and fifth exemplary embodiments, the mask layer 143 and the resin layer 144 are formed over the substrate 142 and the substrate 142 is indirectly processed into a concavo-convex pattern based on the resin layer 144 having a concavo-convex pattern. However, the material, the thickness and the number of mask layers are not specifically limited, as long as the basic concavo-convex pattern or a concavo-convex pattern close to the basic concavo-convex pattern can be formed on the master disk 140. For example, two or more mask layers may be provided between the substrate and the resin layer and those layers may be sequentially processed into a concavo-convex pattern. Alternatively, the mask layer may be omitted and the resin layer may be deposited on the substrate directly, so that the substrate is directly processed into a concavo-convex portion based on the resin layer.

In the first exemplary embodiment, the resist material 44 in the master disk 46 is a positive resist. However, a negative resist can be used. In this case, portions of the resist material 44 corresponding to concave portions in an irregular concavo-convex portion are exposed, a stamper having a transfer surface of a concavo-convex pattern that has the same positional relationship between convex portions and concave portions as the irregular concavo-convex pattern is manufactured, and another stamper is manufactured using that stamper as a metal master (master disk). In this manner, it is also possible to obtain a stamper having a transfer surface having the same concavo-convex pattern of the stamper 40 of the first exemplary embodiment. Therefore, when the irregular concavo-convex pattern is transferred onto the resin layer 52 by imprinting using that stamper, the thickness of the resin layer 52 remaining in the bottom of the concave portions can be made small and uniform in the entire region and the resin layer 52 can be processed into the irregular concavo-convex pattern with high precision. Alternatively, when portions of the resist material corresponding to the convex portions of the irregular concavo-convex pattern are exposed, a stamper having a transfer surface having a reversed concavo-convex pattern of the irregular concavo-convex pattern can be manufactured, as in the first exemplary embodiment.

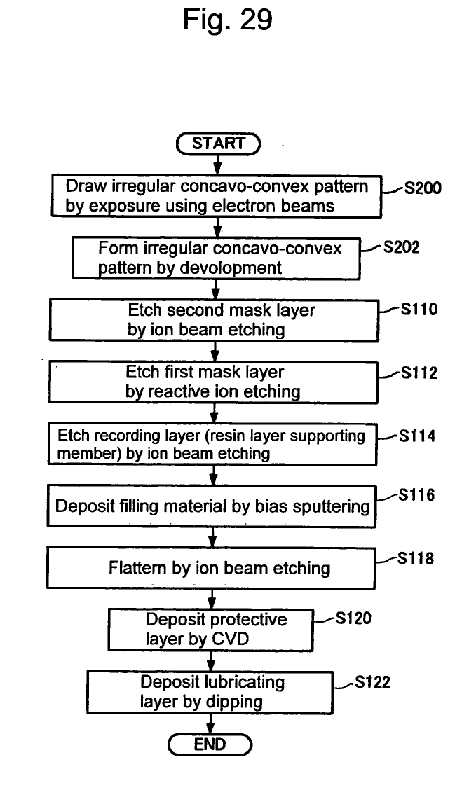

In the first exemplary embodiment, the resin layer 52 in the object to be processed 54 is processed into an irregular concavo-convex pattern by imprinting using the stamper 40. However, a resist material may be used for the resin layer 52 and the resin layer 52 may be processed into the irregular concavo-convex pattern by exposure (S200) and development (S202) as in the seventh exemplary embodiment shown in the flowchart of FIG. 29. In this case, by applying an irregular concavo-convex servo pattern in which at least some of the concave portions are divided as compared with corresponding concave portions of the basic concavo-convex servo pattern to portions of the resin layer 52 in the servo areas SA, it is possible to adjust a dose in exposure to a value close to an appropriate value for the entire region of the resin layer 52 and process the resin layer 52 into a desired concavo-convex pattern containing the irregular servo pattern with high precision. Since the resin layer 52 does not remain in the bottom of the concave portion in this case, the resin layer etching step (S108) is not required. Moreover, in this case, the dividing convex portions 52A of the resin layer 52 can be removed in the second mask layer etching step (S110). That is, the second mask layer 50 can be etched while completely removing the dividing convex portions 52A of the resin layer 52 in the second mask layer etching step (S110). In this etching, it is preferable to process the second mask layer 50 so as not to form convex portions in regions corresponding to the dividing convex portions 52A. In addition, the dividing convex portions 52A of the resin layer 52 and the convex portions of the second mask layer 50 or first mask layer 48 corresponding thereto may be removed during sequential etching of the second mask layer 50, the first mask layer 48, and the recording layer 12 based on the resin layer 52.

In the third to sixth exemplary embodiments, the substrate 142 is processed into a concavo-convex pattern as the resin layer supporting member. Alternatively, a resin layer supporting member different from the substrate may be provided on the substrate. In this case, the resin layer is deposited over the resin layer supporting member directly or indirectly via a mask layer or the like, and the resin layer supporting member is processed into a concavo-convex pattern based on the resin layer having a concavo-convex pattern directly or indirectly (without processing the substrate).

In the third and fifth exemplary embodiments, the master disk 140 includes the substrate 142 and the mask layer 143 formed on the convex portion of the substrate 142. Alternatively, a master disk in which a substrate serving as a resin layer supporting member or a resin layer supporting member provided over the substrate is processed into a concavo-convex pattern and then a mask layer is removed may be used.

In the third to sixth exemplary embodiments, the stamper 110 is manufactured by depositing the conductive film 148 and the electrolytic plating layer 150 over the master disk 140 or 160 and then separating them as one unit. Alternatively, the conductive film 148 and the electrolytic plating layer 150 may be used as a metal master from which a stamper is formed by electrolytic plating. In this case, the stamper having the same concavo-convex relationship as the master disk 140 can be obtained. Moreover, the metal master and the stamper may be manufactured by further repeating the electrolytic plating.

In the third to sixth exemplary embodiments, the material for the conductive film 148 is Ni. However, other conductive materials such as Ag, Au, and Cu can be used.

In the third to sixth exemplary embodiments, the material for the electrolytic plating layer 150 is also Ni. However, other materials such as Ni—Co (cobalt) alloys can be used for the electrolytic plating layer and the stamper, as long as those materials have appropriate hardness and ductility as a stamper and a metal master.

In the third and fifth exemplary embodiments, the stamper 110 including the conductive film 148 and the electrolytic plating layer 150 is manufactured by performing the conductive film deposition step (S512) and the electrolytic plating step (S514) for the master disk 140. Alternatively, a conductive material may be used as the material for the substrate (resin layer supporting member) of the master disk and the conductive film deposition step (S512) may be omitted. In this case, a stamper or metal master that does not include the conductive film but includes the electrolytic plating layer only can be obtained.

In the first to seventh exemplary embodiments, the concave portions between the convex portions of the recording layer 12 are filled with the filling material 28 in the magnetic recording medium 10. However, the concave portions between the convex portions of the recording layer 12 may not be filled, as long as a sufficiently good flying performance of the magnetic head can be obtained.

In the first to seventh exemplary embodiments, the magnetic recording medium 10 is a discrete track medium in which portions of the recording layer 12 in the data areas DA are divided into a number of recording elements 14 at fine intervals in the radial direction Dr. However, the present invention can be also applied to a patterned medium in which the portions of the recording layer in the data areas DA are divided into a number of recording elements at fine intervals in both the radial direction Dr and the circumferential direction Dc and a magnetic recording medium in which the portions of the recording layer in the data areas DA are continuous with a uniform thickness.

In the first to seventh exemplary embodiments, the magnetic recording medium 10 is a perpendicular recording type. However, the present invention can be also applied to manufacturing of a longitudinal recording type magnetic recording medium.

Although the first to seventh exemplary embodiments of the present invention relates to manufacturing of the magnetic recording medium 10, the present invention can be also applied to manufacturing of other information recording media, e.g., optical recording media, and other products, e.g., semiconductor products.

1. A method for forming a concavo-convex pattern comprising:
an irregular concavo-convex pattern formation step of processing a resin layer formed over a resin layer supporting member into an irregular concavo-convex pattern in which a dividing convex portion is formed in a part of concave portions of a predetermined basic concavo-convex pattern and at least some of concave portions are divided as compared with corresponding concave portions of the basic concavo-convex pattern; and
a resin layer supporting member etching step of etching the resin layer supporting member based on the resin layer to process the resin layer supporting member into a concavo-convex pattern obtained by bringing the irregular concavo-convex pattern close to the basic concavo-convex pattern.

2. The method for forming a concavo-convex pattern according to claim 1, wherein
further comprising a resin layer etching step of etching the resin layer to selectively remove the dividing convex portion out of convex portions of the resin layer between the irregular concavo-convex pattern formation step and the resin layer supporting member etching step.

3. The method for forming a concavo-convex pattern according to claim 1, wherein
a mask layer serving as a mask in the resin layer supporting member etching step is formed between the resin layer supporting member and the resin layer; and
a mask layer etching step of etching the mask layer based on the resin layer while removing the dividing convex portion of the resin layer is provided between the irregular concavo-convex pattern formation step and the resin layer supporting member etching step.

4. The method for forming a concavo-convex pattern according to claim 1, wherein
the basic concavo-convex pattern is one in which each of a plurality of cell areas is specified as either one of a concave unit area forming a concave portion and a convex unit area forming a convex portion in a binary fashion in accordance with a predetermined rule; and
in the irregular concavo-convex pattern formation step, the resin layer is processed into the irregular concavo-convex pattern in which the dividing convex portion is formed near a boundary of at least two adjoining concave unit areas out of the concave unit areas and concave portions divided by the dividing convex portion are formed in the adjoining concave unit areas.

5. The method for forming a concavo-convex pattern according to claim 1, wherein
the resin layer supporting member is etched so as to form a continuous concave portion under the dividing convex portion in the resin layer supporting member etching step.

6. A method for forming a concavo-convex pattern comprising:
an irregular concavo-convex pattern formation step of processing a resin layer formed over a resin layer supporting member into an irregular concavo-convex pattern in which a dividing convex portion is formed in a part of concave portions of
a predetermined basic concavo-convex pattern and at least some of concave portions are divided as compared with corresponding concave portions of the basic concavo-convex pattern; and
a resin layer etching step of etching the resin layer to process the resin layer into a concavo-convex pattern obtained by bringing the irregular concavo-convex pattern close to the basic concavo-convex pattern.

7. The method for forming a concavo-convex pattern according to claim 6, wherein
the resin layer is etched in the resin layer etching step so as to selectively remove the dividing convex portion out of convex portions of the resin layer.

8. The method for forming a concavo-convex pattern according to claim 1, wherein
in the irregular concavo-convex pattern formation step, the resin layer is processed into the irregular concavo-convex pattern in which at least some of corners of convex portions that respectively project toward adjacent concave portions have projections that project more toward the adjacent concave portions as compared with corresponding corners of the basic concavo-convex pattern.

9. A method for forming a concavo-convex pattern comprising:
an irregular concavo-convex pattern formation step of processing a resin layer formed over a resin layer supporting member into an irregular concavo-convex pattern in which at least some of corners of convex portions projecting toward adjacent concave portions have projections that project more toward the adjacent concave portions as compared with corresponding corners of a predetermined basic concavo-convex pattern; and
a resin layer supporting member etching step of etching the resin layer supporting member based on the resin layer to process the resin layer supporting member into a concavo-convex pattern obtained by bringing the irregular concavo-convex pattern close to the basic concavo-convex pattern.

10. A method for forming a concavo-convex pattern comprising:
an irregular concavo-convex pattern formation step of processing a resin layer formed over a resin layer supporting member into an irregular concavo-convex pattern in which at least some of corners of convex portions projecting toward adjacent concave portions have projections that project more toward the adjacent concave portions as compared with corresponding corners of a predetermined basic concavo-convex pattern; and
a resin layer etching step of etching the resin layer to process the resin layer into a concavo-convex pattern obtained by bringing the irregular concavo-convex pattern close to the basic concavo-convex pattern.

11. The method for forming a concavo-convex pattern according to claim 1, wherein
the resin layer is processed into the irregular concavo-convex pattern by imprinting using a stamper in the irregular concavo-convex pattern formation step.

12. The method for forming a concavo-convex pattern according to claim 1, wherein
a resist material is used for a material of the resin layer and the resin layer is processed into the irregular concavo-convex pattern by exposure and development in the irregular concavo-convex pattern formation step.

13. A method for manufacturing a magnetic recording medium including a recording layer having a concavo-convex pattern by using the method for forming a concavo-convex pattern according to claim 1.

14. The method for manufacturing a magnetic recording medium according to claim 13, wherein
the magnetic recording medium being sectioned into a plurality of data areas and a plurality of servo areas, and each of the servo areas being further sectioned into a plurality of cell areas, either one of an information on 0 and an information on 1 being recorded on each of the cell areas of the recording layer for use in a binary fashion in accordance with a predetermined rule;
a portion of the recording layer is processed in each servo area into a concavo-convex pattern in which the cell areas for recording either one of the information on 0 and the information on 1 therein are concave portions and the other cell areas for recording the other information therein are convex portions; and
the portion of the recording layer in each servo area is processed by a method for forming a concavo-convex pattern, comprising:
an irregular concavo-convex pattern formation step of processing a resin layer formed over a resin layer supporting member into an irregular concavo-convex pattern in which a dividing convex portion is formed in a part of concave portions of a predetermined basic concavo-convex pattern and at least some of concave portions are divided as compared with corresponding concave portions of the basic concavo-convex pattern; and
a resin layer supporting member etching step of etching the resin layer supporting member based on the resin layer to process the resin layer supporting member into a concavo-convex pattern obtained by bringing the irregular concavo-convex pattern close to the basic concavo-convex pattern.

15. The method for manufacturing a magnetic recording medium according to claim 14, wherein
in the irregular concavo-convex pattern formation step, the resin layer is processed into the irregular concavo-convex pattern in which the dividing convex portion is formed near a boundary of at least two cell areas corresponding to concave portions, adjoining in a radial direction of the magnetic recording medium and concave portions divided in the radial direction are formed in a region corresponding to the adjoining cell areas.

16. A method for manufacturing a master disk for transferring a concavo-convex pattern by using the method for forming a concavo-convex pattern according to claim 1.

17. A method for manufacturing a master disk for transferring a concavo-convex pattern by using the method for forming a concavo-convex pattern according to claim 6.

18. A method for manufacturing a master disk for transferring a concavo-convex pattern by using the method for forming a concavo-convex pattern according to claim 9.

19. A method for manufacturing a master disk for transferring a concavo-convex pattern by using the method for forming a concavo-convex pattern according to claim 10.

20. The method for manufacturing a master disk according to claim 16, wherein
the master disk having a concavo-convex pattern corresponding to a concavo-convex pattern of a recording layer of a magnetic recording medium, the magnetic recording medium being partitioned into a plurality of data areas and a plurality of servo areas, each of the servo areas being further partitioned into a plurality of cell areas, either one of an information on 0 and an information on 1 being recorded on each of the cell areas of the recording layer for use in a binary fashion according to a predetermined rule, the recording layer being formed in the concavo-convex pattern having concave portions corresponding to the cell areas for recording either one of the information on 0 and the information on 1, and convex portions corresponding to the other cell areas for recording the other information,
the basic concavo-convex pattern having concave unit areas corresponding to the cell areas for recording either one of the information on 0 and the information on 1, and convex unit areas corresponding to the other cell areas for recording the other information;
in the irregular concavo-convex pattern formation step, the resin layer is processed into the irregular concavo-convex pattern in which the dividing convex portion is formed near a boundary of at least two adjoining concave unit areas out of the concave unit areas of the basic servo concavo-convex pattern and concave portions divided by the dividing convex portion are formed in the adjoining concave unit areas.

21. The method for manufacturing a master disk according to claim 20, wherein
the irregular concavo-convex pattern is one in which the dividing convex portion is formed near a boundary of at least two concave unit areas adjoining in a radial direction of the magnetic recording medium out of the concave unit areas of the basic servo concavo-convex pattern and concave portions divided in the radial direction is formed in the adjoining concave unit areas.

22. A method for manufacturing a stamper, comprising an electrolytic plating step of forming an electrolytic plating layer by electrolytic plating on the master disk manufactured by the method for manufacturing a master disk according to claim 16.

23. A method for manufacturing a stamper, comprising an electrolytic plating step of forming an electrolytic plating layer by electrolytic plating on the master disk manufactured by the method for manufacturing a master disk according to claim 17.

24. A method for manufacturing a stamper, comprising an electrolytic plating step of forming an electrolytic plating layer by electrolytic plating on the master disk manufactured by the method for manufacturing a master disk according to claim 18.

25. A method for manufacturing a stamper, comprising an electrolytic plating step of forming an electrolytic plating layer by electrolytic plating on the master disk manufactured by the method for manufacturing a master disk according to claim 19.

26. The method for manufacturing a stamper according to claim 22, wherein
further comprising, after the electrolytic plating step as a first electrolytic plating step,
a separation step of separating a metal master including the electrolytic plating layer from the master disk; and
a second electrolytic plating step of forming either one of a stamper and another metal master on the separated metal master by electrolytic plating.

27. A method for manufacturing a magnetic recording medium, comprising a step of transferring a concavo-convex pattern corresponding to a concavo-convex pattern of a recording layer by using a stamper manufactured by the method for manufacturing a stamper according to claim 22.

28. A method for manufacturing a magnetic recording medium, comprising a step of transferring a concavo-convex pattern corresponding to a concavo-convex pattern of a recording layer by using a stamper manufactured by the method for manufacturing a stamper according to claim 23.

29. A method for manufacturing a magnetic recording medium, comprising a step of transferring a concavo-convex pattern corresponding to a concavo-convex pattern of a recording layer by using a stamper manufactured by the method for manufacturing a stamper according to claim 24.

30. A method for manufacturing a magnetic recording medium, comprising a step of transferring a concavo-convex pattern corresponding to a concavo-convex pattern of a recording layer by using a stamper manufactured by the method for manufacturing a stamper according to claim 25.
